(19) United States
(12) Patent Application Publication
(10) Pub. No.: US 2016/0032904 A1
(43) Pub. Date: Feb. 4, 2016

(54) CORE REACTOR AND SYSTEM

(71) Applicant: TRANSTAR GROUP, LTD, Wanchai, Hong Kong (CN)

(72) Inventors: Allen KAPLAN, Miami Beach, FL (US); Randall BRADLEY, Ft. Lauderdale, FL (US)

(21) Appl. No.: 14/776,736

(22) PCT Filed: Mar. 18, 2014
(86) PCT No.: PCT/US14/31116

§ 371 Date: Sep. 14, 2015

Related U.S. Application Data
(60) Provisional application No. 61/801,491, filed on Mar. 15, 2013.
(60) Provisional application No. 61/801,170, filed on Mar. 15, 2013.

(51) Int. Cl. F03G 7/00; G21D 5/00

(52) U.S. Cl. CPC F03G 7/00; G21D 5/00

(57) ABSTRACT

A core reactor comprises a multistage single, dual, multi-directional or reversible flow system including at least: 1) a power generation stage; 2) a power amplification stage or stages; 3) apparatus feed and/or an internal processing system; and an optional flow recycle and/or propulsion stage. The core reactor can include the following interconnected components: 1) primary kinetic energy device (s); exhaust nozzles; 2) single or multilevel swirl chambers; 3) single or multiple conical vortex cones; and 4) modified vortex tubes(s) for cryogenic, sonic or extreme thermal heart generation streams. The present core reactor is capable of generating/storing electricity, electrical power and/or energy beams including, inter alia: 1) exothermic and endothermic heat; cryogenic cold; 3) sonic resonance; 4) luminosity; 5) thrust; 6) vacuum; and 7) electromagnetism. Included within the ambit of power amplification are, for example: 1) exhaust nozzle flow amplification; 2) centrifuge power amplification and first stage gas separation; 3) quantum MAGLEV levitated inner swirl chamber flow amplification; and induced flow merging convergent low conical vortex cone(s) including inner flow cone flow compression and outer vortex cone flow entrainment and amplification.

### FIELD OF THE INVENTION

The present invention relates to an integrated advanced matrix of processing, propulsion and electric power generation derived from a modifiable core reactor capable of generating energy beams on an individual or mixed beam basis.

The present inventions utilizes a core reactor which comprises a multistage single, dual, multi-directional or reversible flow system including at least: 1) a power generation stage; 2) a power amplification stage or stages; 3) apparatus feed and/or an internal processing system; and an optional flow recycle and/or propulsion stage. The core reactor can include the following interconnected components: 1) primary kinetic energy device (s); exhaust nozzles; 2) single or multilevel swirl chambers; 3) single or multiple conical vortex cones; and 4) modified vortex tubes(s) for cryogenic, sonic or extreme thermal heart generation streams. The first stage power generation can be, for example, primary kinetic power generation or primary thermal heat generation.

The present core reactor is capable of generating/storing electricity, electrical power and/or energy beams including, inter alia: 1) exothermic and endothermic heat; cryogenic cold; 3) sonic resonance; 4) luminosity; 5) thrust; 6) vacuum; and 7) electromagnetism. Included within the ambit of power amplification are, for example: 1) exhaust nozzle flow amplification; 2) centrifuge power amplification and first stage gas separation; 3) quantum MAGLEV levitated inner swirl chamber flow amplification; and induced flow merging convergent low conical vortex cone(s) including inner flow cone flow compression and outer vortex cone flow entrainment and amplification.

The apparatus feed and/or internal processing system may include, for example: 1) vortex tube system self-generating (internal systems) including an extreme thermal heat processing stream, an extreme magnetic, electromagnet or superconductive flux field or an extreme cryogenic cold processing system; and 2) central chambered pulse detonation tube(s) including; a) feed processing distribution cap to detonation tube; b) detonation compression; c) advanced separation nozzle system; and d) separated feed collection and removal. For the final propulsion phase, quadrapole detonation, compression and or/combined Penning Trap.

Optional flow recycle and/or propulsion can encompass, for example: 1) secondary processing (optional) including flow recuperation purification and system recycle and focused energy beam release; and 2) propulsion and system recuperator recycle (optional) including, e.g.: divergent propulsion nozzle thrust release and flow recuperator purification and system recycle.

The present core reactor can comprise, for example, the following elements: 1) primary kinectic energy device(s) including inter alia an inventive MAGLEV quantum trapping turbine and current art engine adaptable, quadrapole electric field, Penning Trap for subatomic particles; 2) exhaust nozzle(s) with thrust booster; 3) swirl chamber(s) which can be single or multi-level; 4) single or multiple conical vortex cones, such as, for example: a) flow compression (multiplier ring); b) flow expansion option; c) secondary layered option; or d) multiple layered option; and 5) modified vortex tube(s) for cryogenic and extreme heat generation streams including, for example: a) detonation compression tube adaptable including colloid subsystem thruster assist, dual polarity and pulsed measured detonation compression; b) gaseous diffusion chamber(s) option; c) asymmetrical separation chambers single line feed; d) advanced double deflection separation nozzle system; e) porous barrier separation and filter grid)(s); 6) hole size tailored to process feed(s); barrier feed separation classifying, and filtering of materials optionally include metal-based, substrated and/or templated: Chalcogenide, Chalcogels, organic, non-organic, crossed-linked, carbon, silica and metal-doped Aerogels colloids, foam metal, foam glass, Xerogel, metamaterials, microporous membranes and other porous, foam, composite, ceramic or advanced materials.

### BRIEF DESCRIPTION OF THE FIGURES

For a more complete understanding of the present invention, including its features and advantages, reference is now made to the detailed description of the invention taken in conjunction with the accompanying drawing in which:

FIG. 1 shows a cross-sectional view of the core reactor.

FIGS. 2a and 2b show another cross-sectional view of the core reactor.

FIG. 3 shows the propulsion view of the core reactor.

FIG. 4 shows another cross-sectional view of the core reactor.

FIG. 5 shows a view of the core reactor being used with another reactor or function.

FIG. 6 shows a schematic of a matrix in which the core reactor can be used.

FIG. 7 shows a schematic of a matrix in which the core reactor can be used in which the core reactor is present and a mining system.

FIG. 7A shows the mining system.

FIGS. 8A and 8B show a multilevel flow diverter.

FIG. 9 shows a flow diverter.

FIG. 10 shows an apparatus representing the MAGLEV generator.

FIGS. 11-38 are diagrams of various reactors and portions of the matrix.

### DETAILED DESCRIPTION OF THE FIGURES

The present invention is further described in the detailed description which follows, in reference to the drawings by way of non-limiting examples of embodiments of the present invention, in which like reference numerals represent similar parts throughout the several views of the drawings. The particulars shown herein are provided by way of example and for purposes of illustrative discussion of the embodiments of the present invention only, and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making it apparent to those skilled in the relevant art how the several forms of the present invention may be embodied and used in practice.

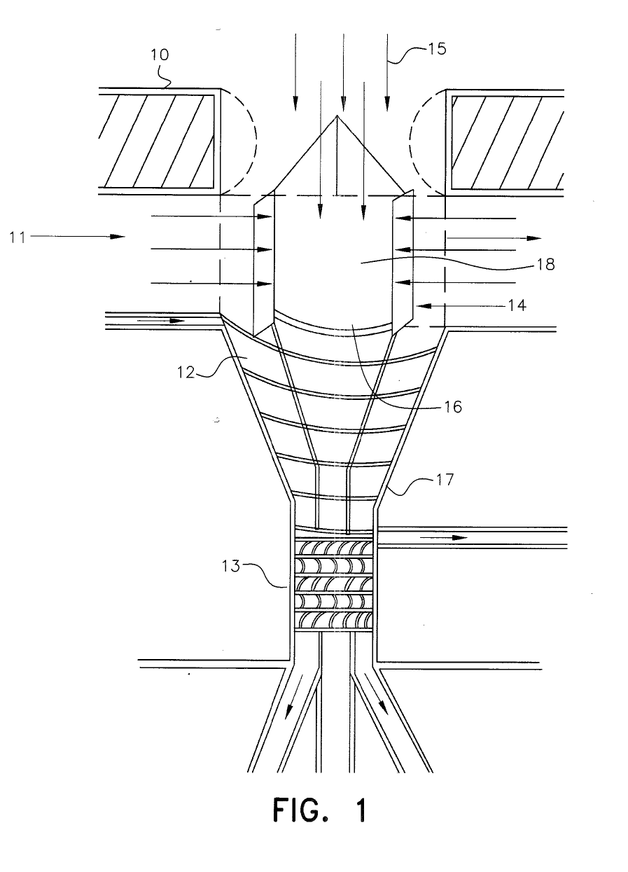

FIG. 1 shows a cross-sectional view of the present invention core reactor. The core reactor 10 has an outer wall 17 and a top and/or alternatively bottom apparatus ram air inlet as the system may be reversible 15. Provided are horizontal inlet ports 11 (which can be single or multiple). Within the core reactor 10 is a swirl chamber 18 and an inner compression vortex 16. Flow vanes 14 are provided within the reactor 10 as well as a Maglev axial compressor 13 and an outer vortex flow channel 12.

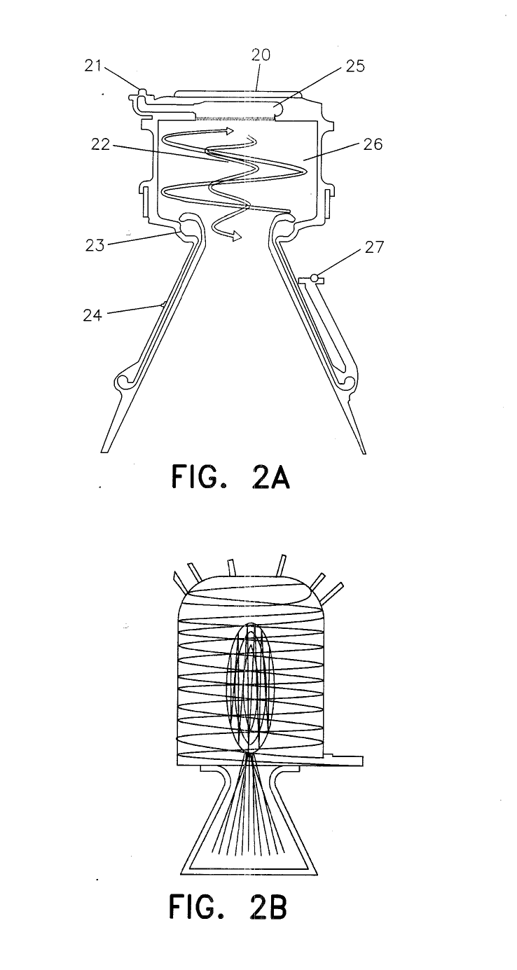

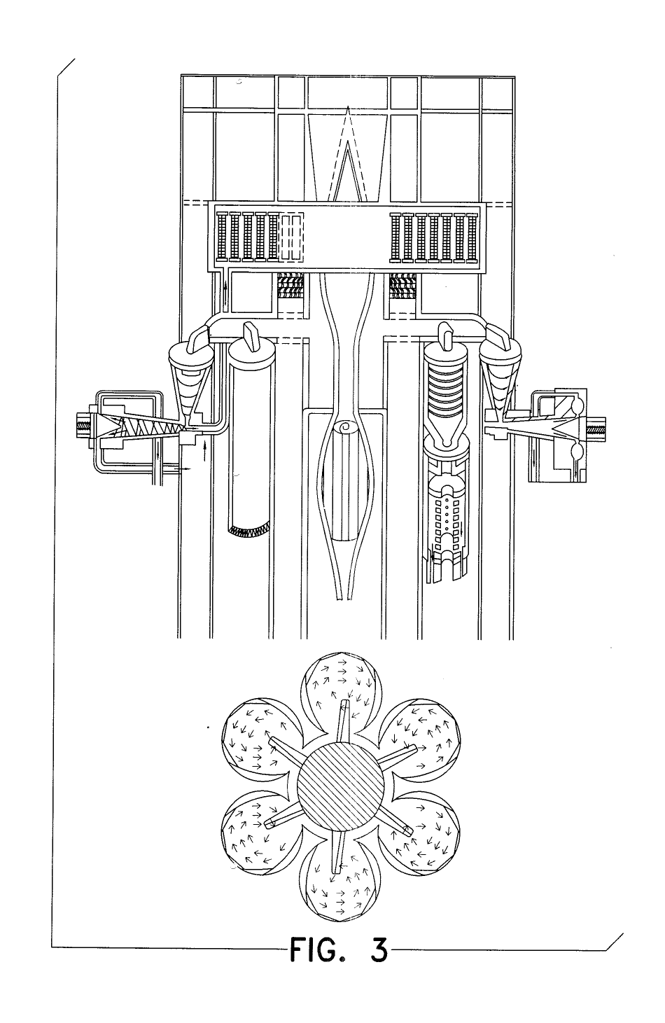

FIG. 2a. is a cross-section of the present core reactor 20 in the form of a cross-section of a vortex gun barrel as, for example, a propulsion unit. The unit has an outer wall 28 and fuel inlet 21 and oxidizer inlet 27. Seen within the unit are inner vortex 22 and outer vortex 26. A Regen cooling LOX channel 24 is provided with the unit wall 28 and also provided is an oxidizer manifold and swirl injector 23 and a fluid manifold and injector 25.

FIG. 2b. illustrates another view of the vortex reactor.

FIG. 3 entitled PROPULSION is best described as a Vortex Accelerator. While it is possible to combine a powder vortex ram accelerator with the vortex gun, the device is best called a vortex accelerator. For the purposes of the application, the following description is for a gun. It is mainly a form of accelerator technology for flows. This example, and its simplicity make it the cheapest member of the vortex gun family of the present invention.

The dual vortex flow within an enclosed combustion chamber prevents the reactor walls from melting when deep thermal temperatures are reached in the combustion process. The outer vortex is typically a cryogenically cooled carrier gas and or fuel oxidant which allows for the slower mixing of fuel and prevention of a pre-detonation prior to such mixing being completed.

Additionally detonation flow accelerants can be injected and detonated anywhere along the core invention's system's vortex flow paths and as well as the other invention's variations in order to reach previously unattainable flow speeds, pressures, thrust levels, extreme thermal temperatures by the entrained voracically levels of compressed and amplified kinetic energy beams.

When the ignition and combustion is used primarily for propulsion you can induce the outer vortex with a pre-measured detonation that allows for the reactor wall protection during the primary fuel combustion. Use of the word “Pyrotechnics” in the application is related to the packing techniques as it covers the gamut of technologies.

The mention of wings and the nose cone are related to the spiral vortex gun's internal sabot which includes 1.) a single, dual or multiple opposing shafts connected by a crossbar with each shaft having a blunt tip and or a nose cone, 2.) attached to each shaft are various rows of winglike flow guides which generate the helical gas flows and shock waves while maintaining a smooth laminar flow and reduce friction and turbulence, 3.) helical injection fins or ribbons which form pulsed counter flowing vortexes spiral barrel to create a rifling effect around each of the sabot wings and prevent premature ignition.

When detonation is used for internal processing, a pumped flux compression type generator may be used for extreme applications or by alternatively pyrotechnically packing the driving explosives in a manner to achieve the desired effects. The core reactor apparatus accommodates a basic system which can be a single or progressively amplifying system of mild to the next generation of compression, thrust, shock wave, shearing, and thermal heat generation.

The core reactor and system invention may, for example, utilize an initial single detonation or a series of detonations with a driving explosive, a transiting explosive, and/or explosive lens with each charge containing a progressive detonator tip. The progressive amplifying system is contained, but may alternatively work in a progressive “ring and finger” series which as the hollow ring detonates it encircles the reciprocating “finger” located downstream of the detonation. This type of progressive detonation allows for an optimized flow into the processing target and allows for the creation of a uniform horizontal directional, super compression thermal shock wave for extreme processing effect or horizontal propulsive thrust.

The vortex gun accelerator system may utilize a modifiable sabot assembly that includes such components as a deforamable compression piston or tetryl pellet, a compression projectile with an embedded flat metal plate face, a high density anvil, a pedal burst valve and smooth bore rifled barrel which leads to the processing chamber. The processing chamber may comprise a target anvil, die, other forming or shaping device and/or compression apparatus or, in propulsion, a divergent designed thrust nozzle, aerospike or Hall Thruster type or non-truncated toroidal aerospike of egress technology that accommodates the fuel being utilized. When utilizing the quadrapole or other multi-compression apparatus this system may be replicated for multiple chamber entry to reach higher velocities, pressures, thermal temperatures and optimize thrust at warp speed levels.

In this non-limiting example, a mixture of hydrogen and a fine powder of ammonium nitrate can be pumped through the accelerator. Helical ribbons produce vortex flow of the mixture and prevent premature detonation. The vortex generates a centrifugal force which keeps most of the powder away from the center of the accelerator. A thin, hot boundary layer forms on the nose cone of the projectile and its wings. Powder in the center of the tube burns in the boundary layer before impinging on the nose cone. The density of the mixture is lower in the center of the tube, so the aerodynamic forces may be strong enough to keep the projectile away from the walls of the tube. To prevent fast rotation of the projectile, the vortex alternates between clockwise and counterclockwise direction. The projectile compresses the mixture to the point of ignition and is propelled by vortex flow of the burning mixture. Several rows of flexible wings are attached to the projectile. They are feathered unless gas pressure deflects them.

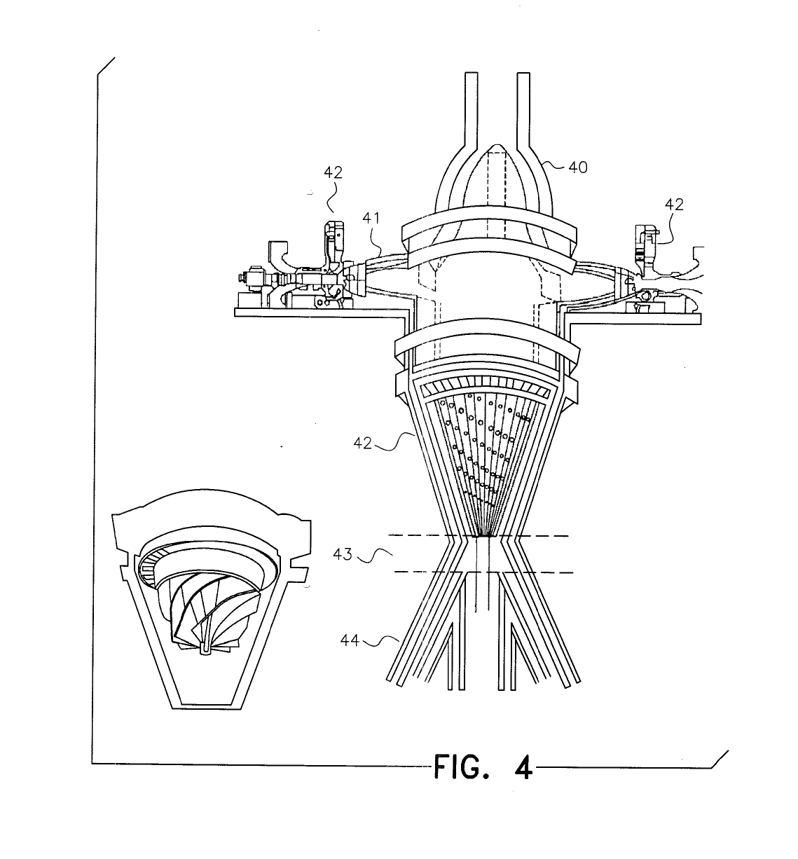

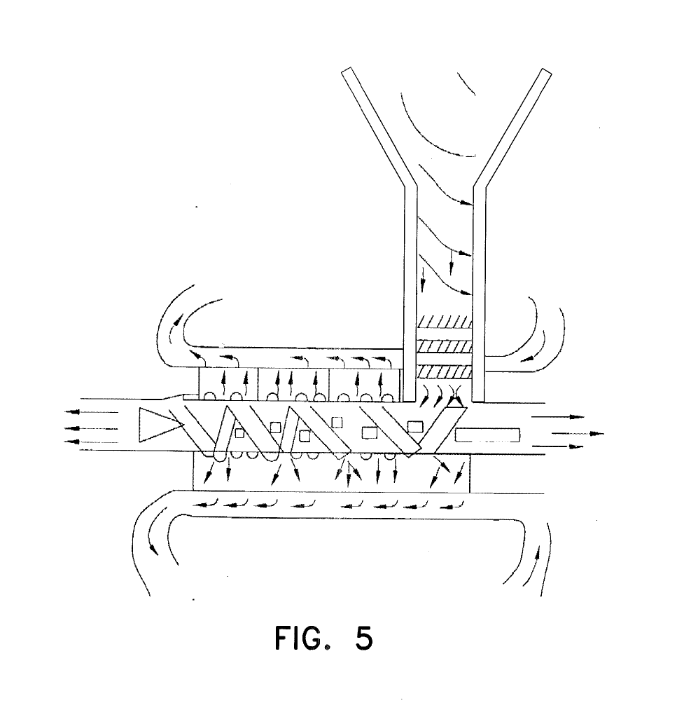

FIGS. 4 and 5 show an embodiment of the present core reactor. FIG. 4 shows a cross-sectional view while FIG. 5 shows a cross-sectional view of the present core reactor portion by which the present core rector may inter-connect to a reactor or functional unit so a to provide power or other functionality to the reactor or functional unit to which the present core reactor is interconnected. FIG. 4 shows the various sections of the present core reactor 40 including the first stage power generation section 41 which can comprise primary kinectic energy generation, primary thermal heat generation, etc. Shown in the figure is an exemplary power input 42 as a gas turbine generator. The second stage 43 is for power amplification such as for example: exhaust nozzle flow amplification; Centrifuge power amplification and first stage gas separation; Quantum levitated inner swirl chamber flow amplifier; Merging convergent flow conical vortex cone(s) including inner vortex cone flow compression with vortex cone flow entrainment and amplification. Third stage 43 comprises apparatus feed and or internal processing system including vortex tube system self-generating (internal systems) including, e.g., extreme thermal heat processing stream and extreme cryogenic cold processing stream or central chambered pulsed detonation tube(s) and Feed processing distribution cap to detonation tube including for example detonation compression, gaseous diffusion separation, advanced separation nozzle system, or separated feed collection and removal. The fourth stage 44 comprises optional flow recycle and or propulsion including a primary and/or secondary processing (option). For example, flow recuperator purification of ram air and dark matter flow and the secondary system recycle or focused energy beam release and propulsion and system recuperator recycle (option) including Divergent propulsion nozzle thrust release or flow recuperator purification and system recycle.

FIG. 5 shows the outlet portion of the core reactor shown in FIG. 4 which is interconnected with a generic reactor or functional unit.

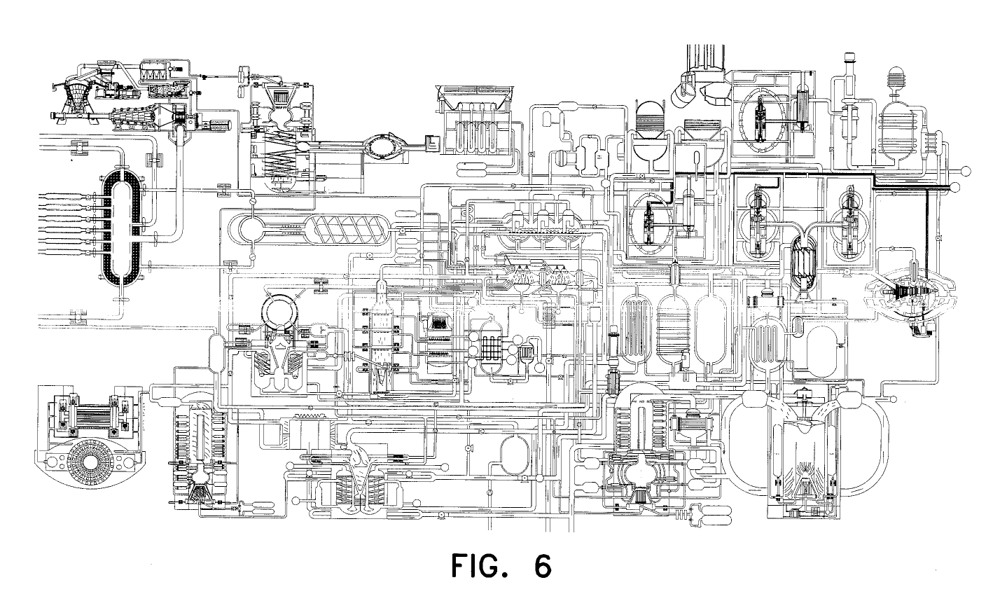

FIG. 6 shows a chart showing an an embodiment of a matrix application in which the present core reactor can be employed. The Matrix application comprises a number of cells in which each cell can provide a particular function wherein the function takes place by the use of a reaction or function reactor. The present core reactor can be used to provide power or other needed actions to facilitate the reactors or functional unit of the cells. The cells and reactors of the cells are shown in FIG. 6 and the descriptions of the cells and functional units are described as follows:

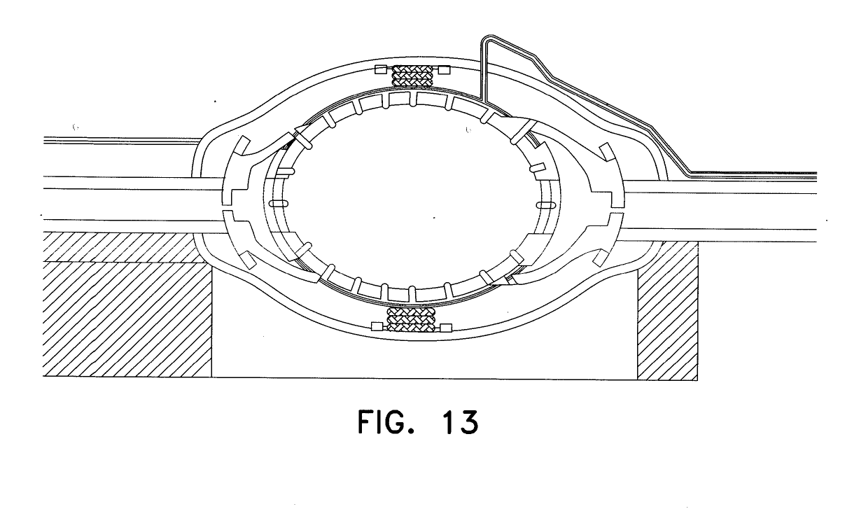

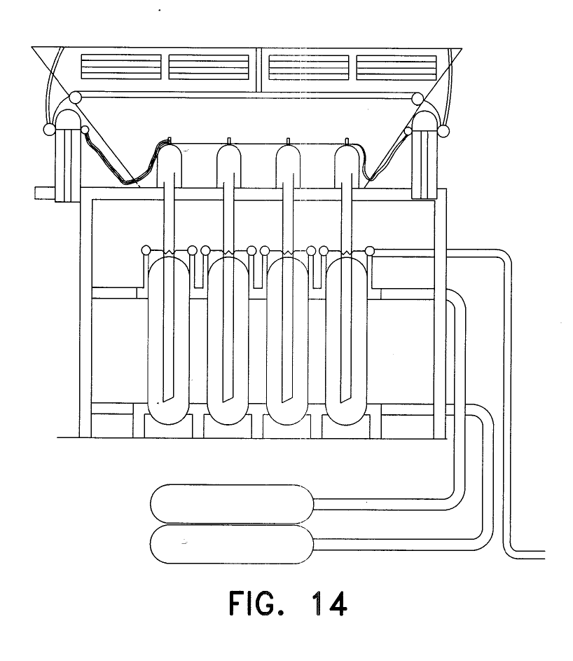

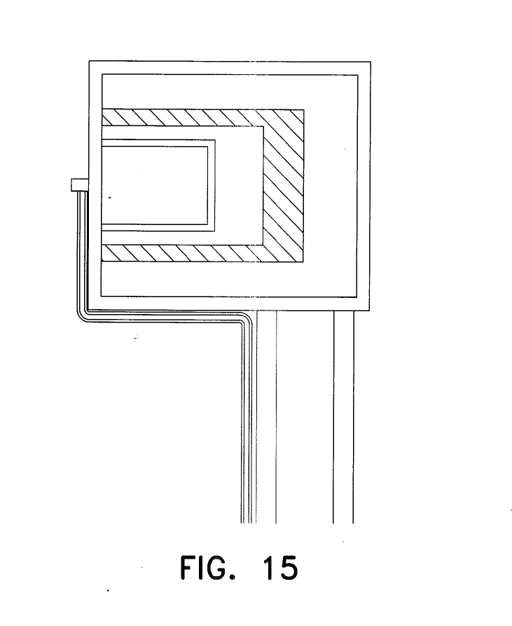

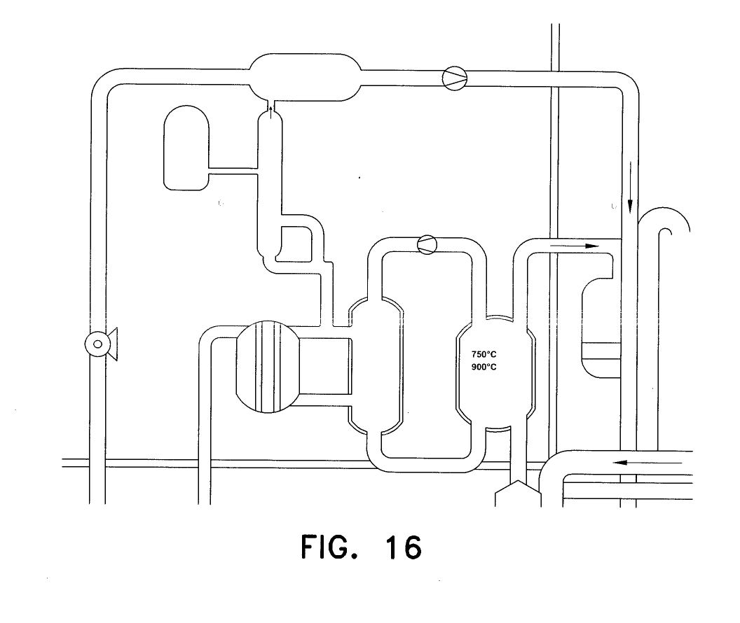

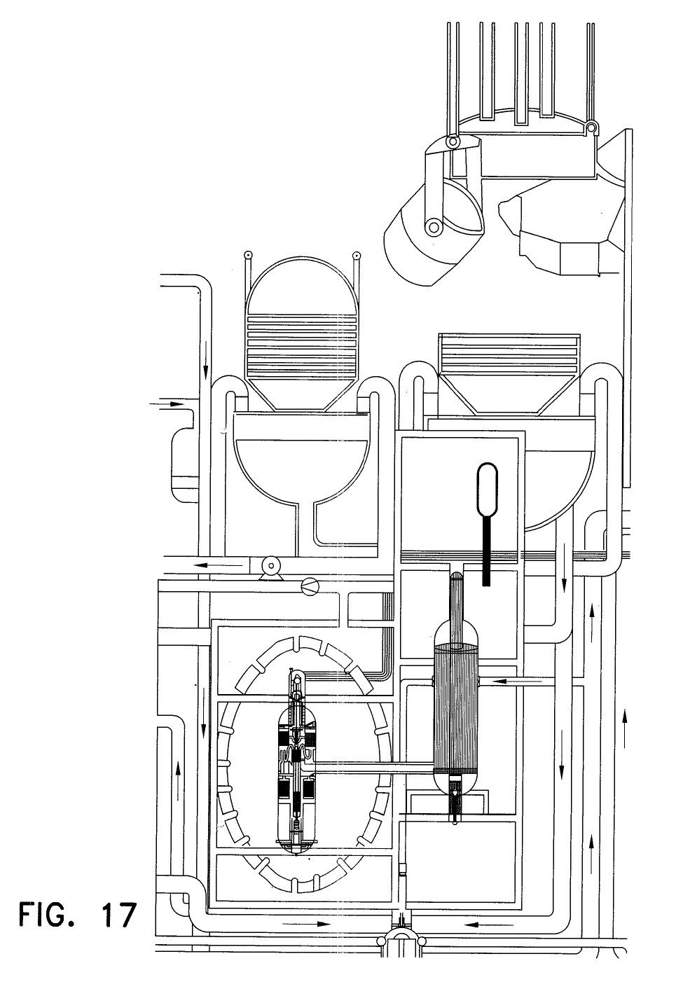

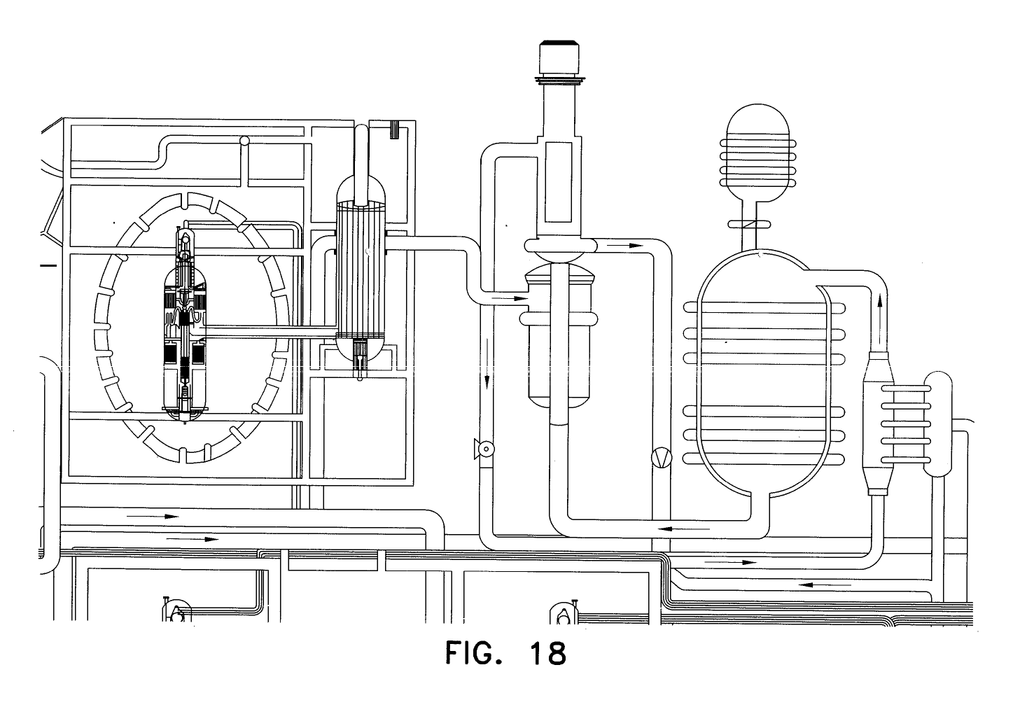

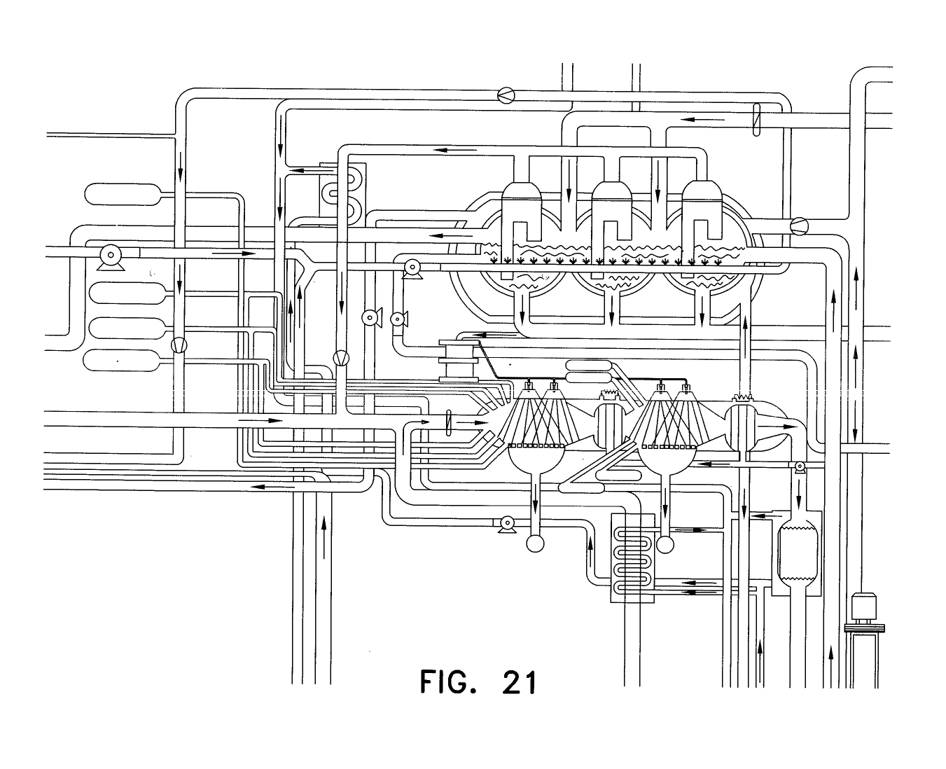

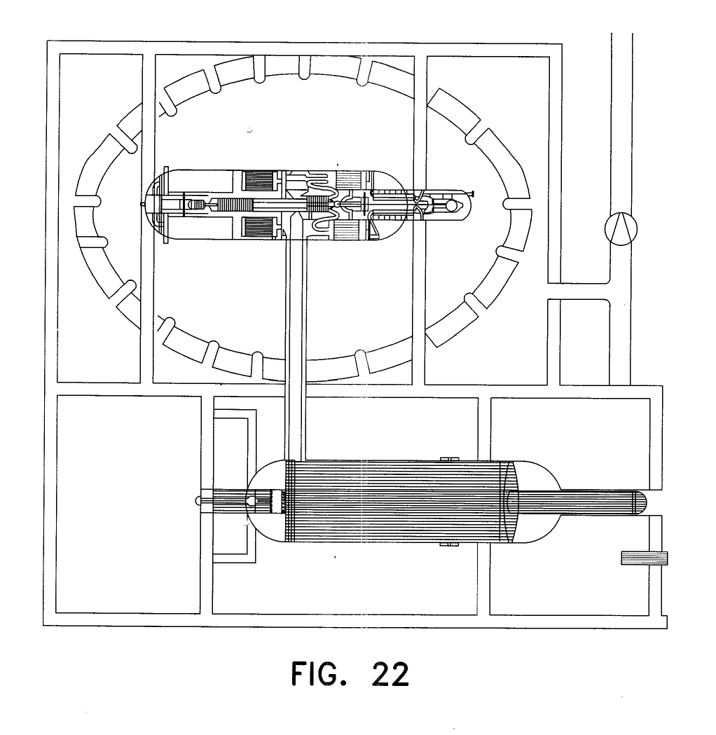

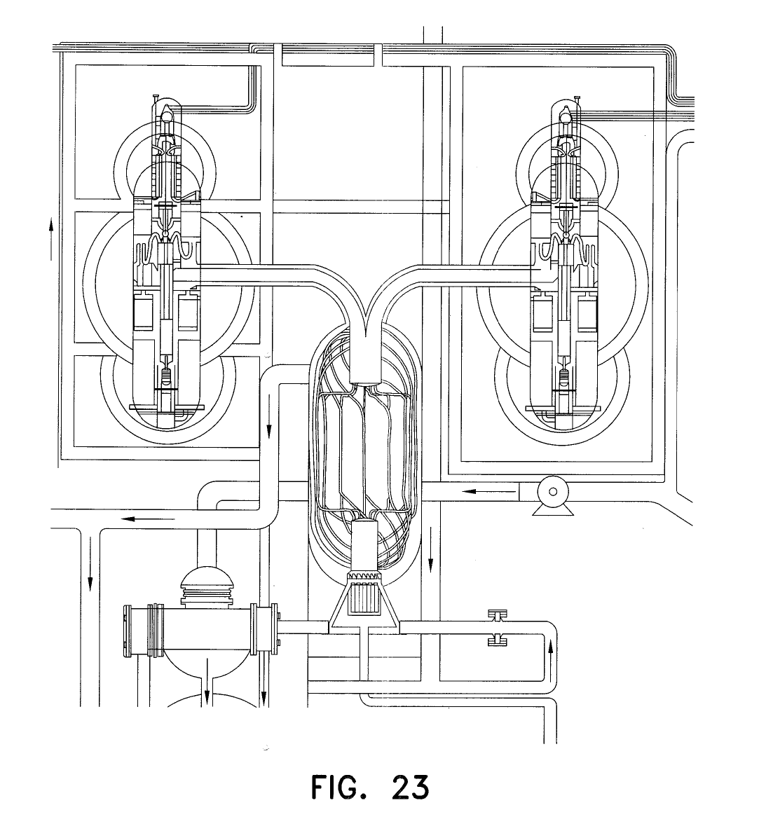

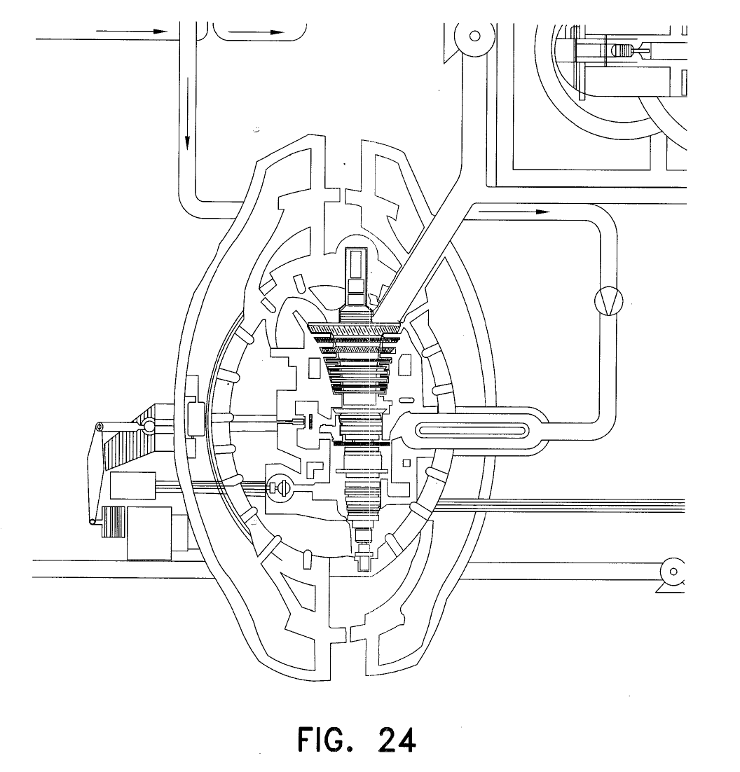

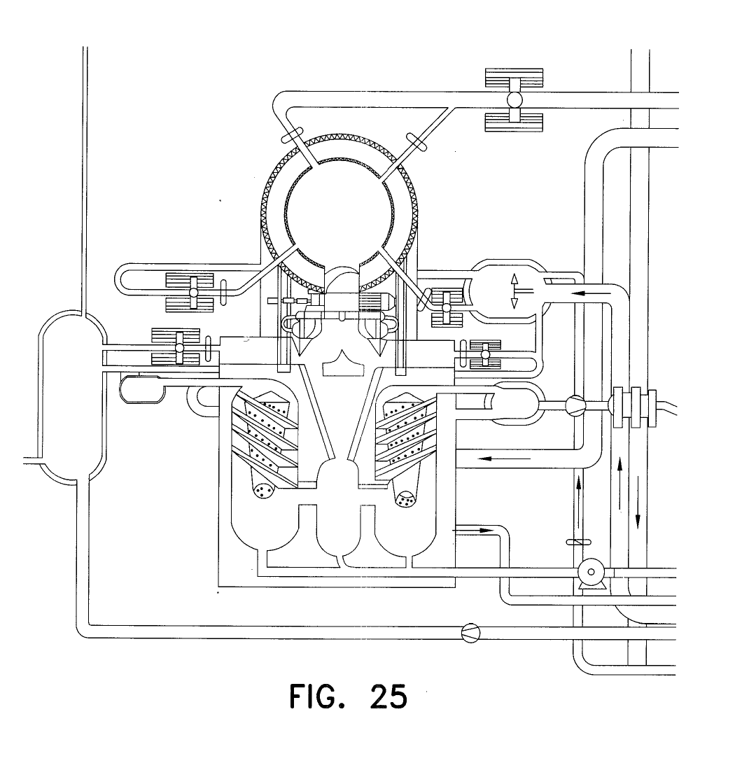

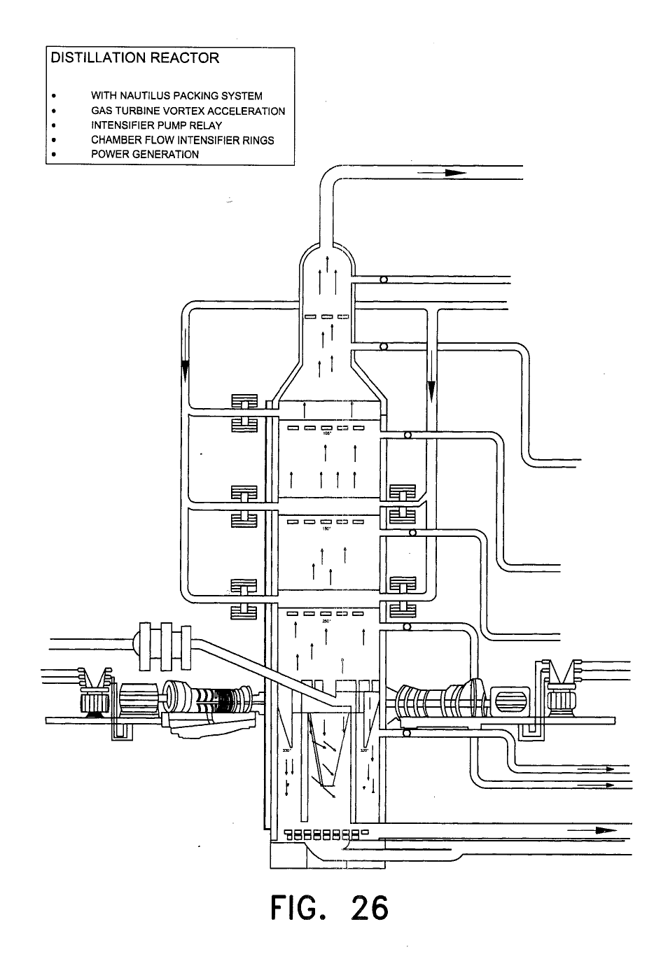

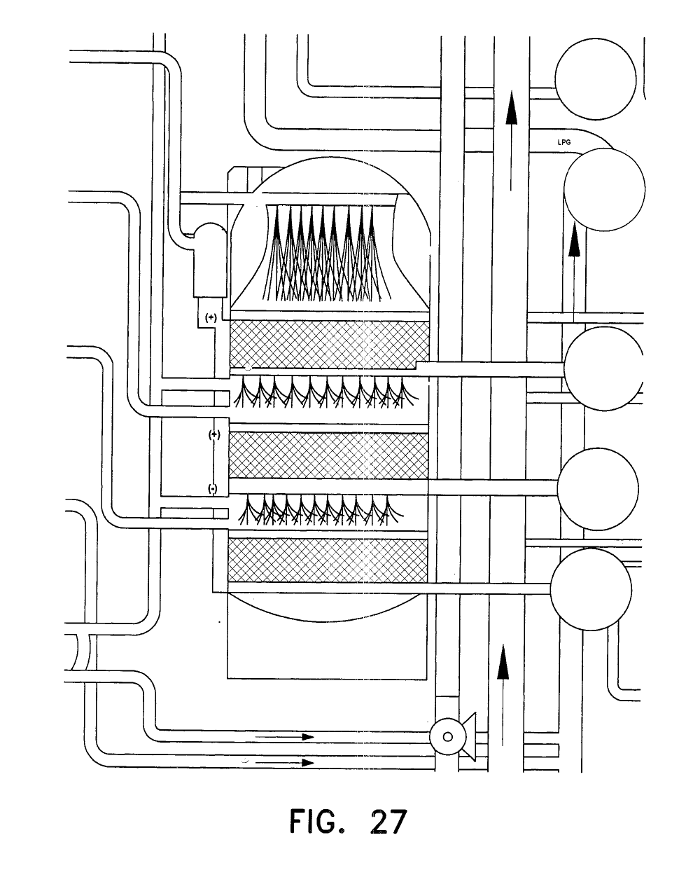

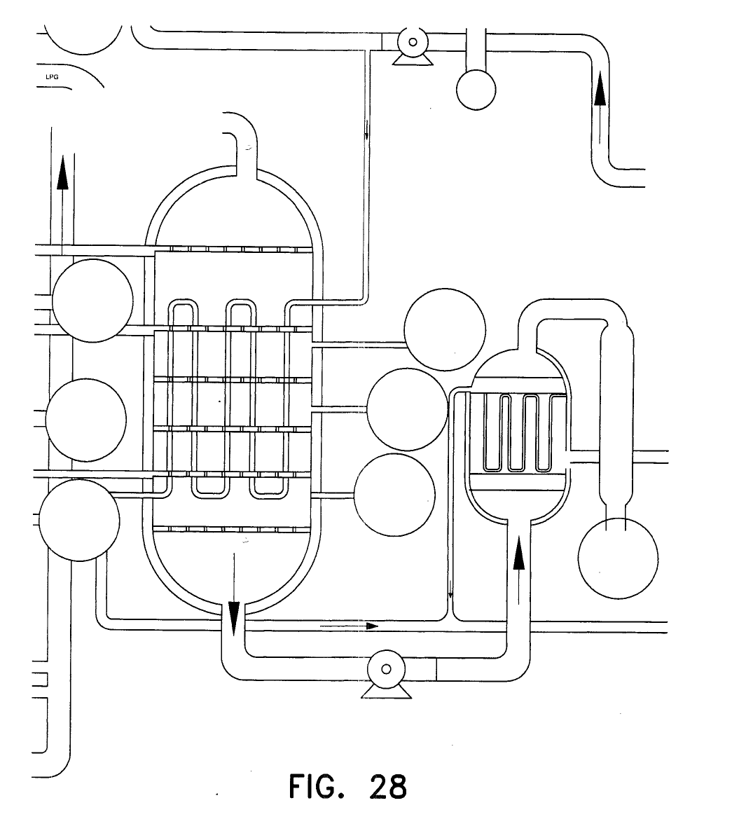

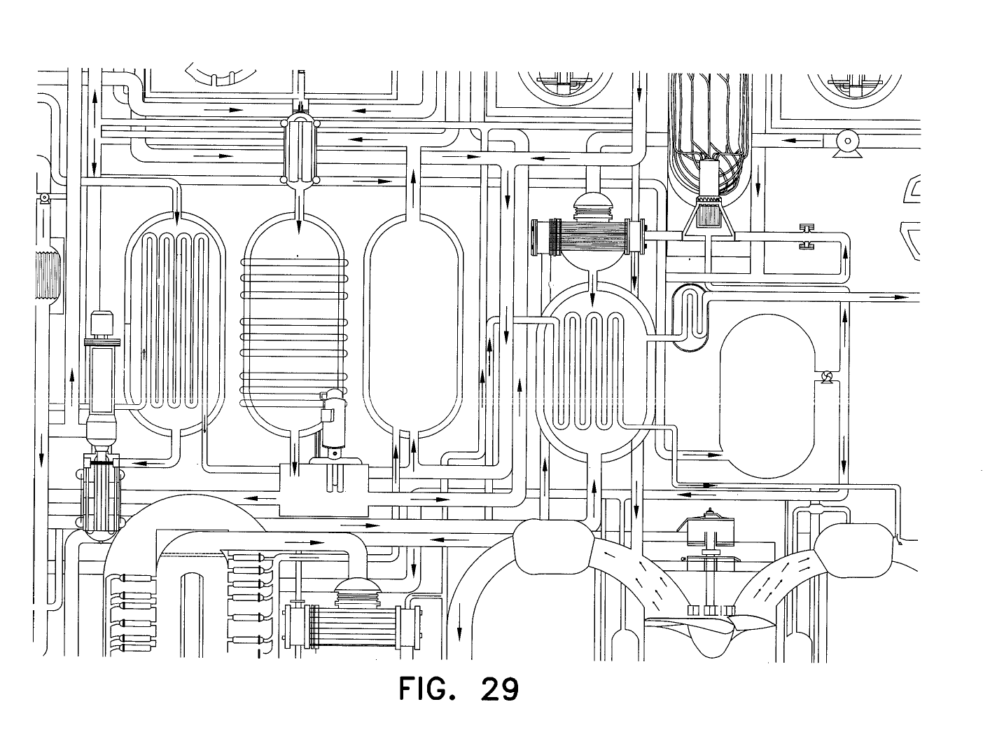

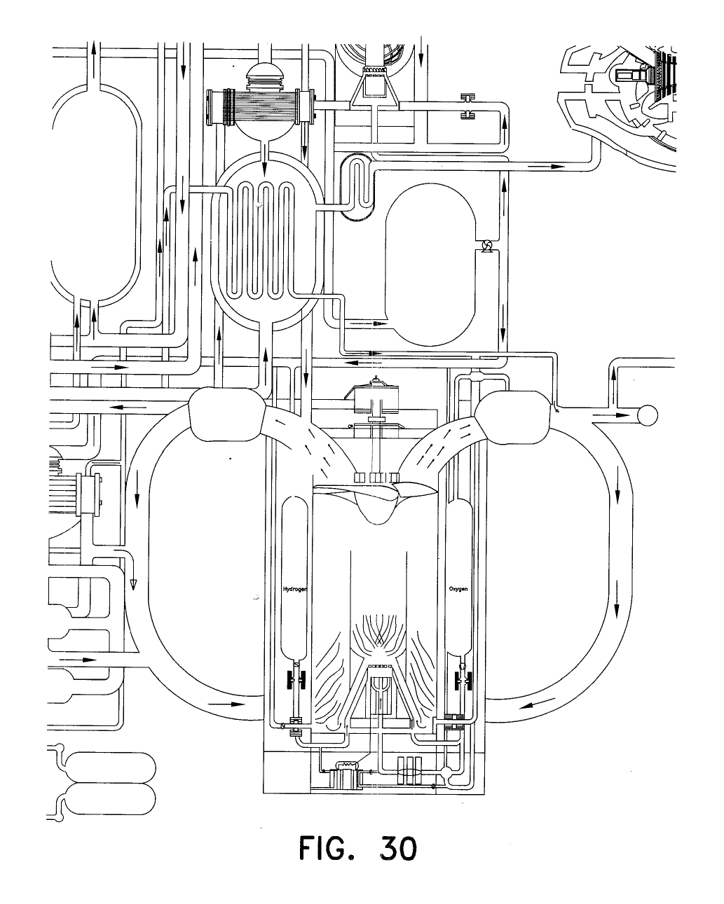

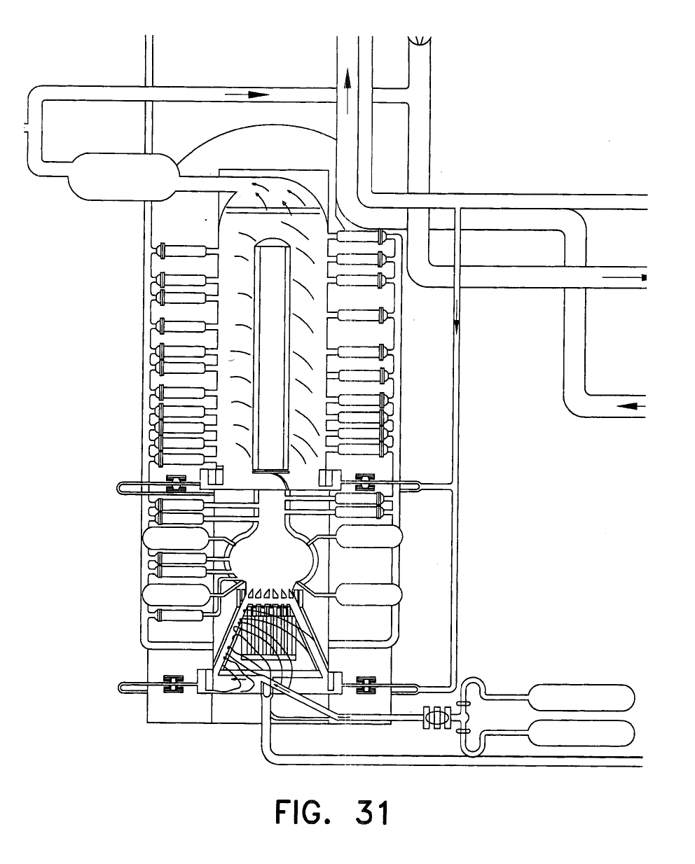

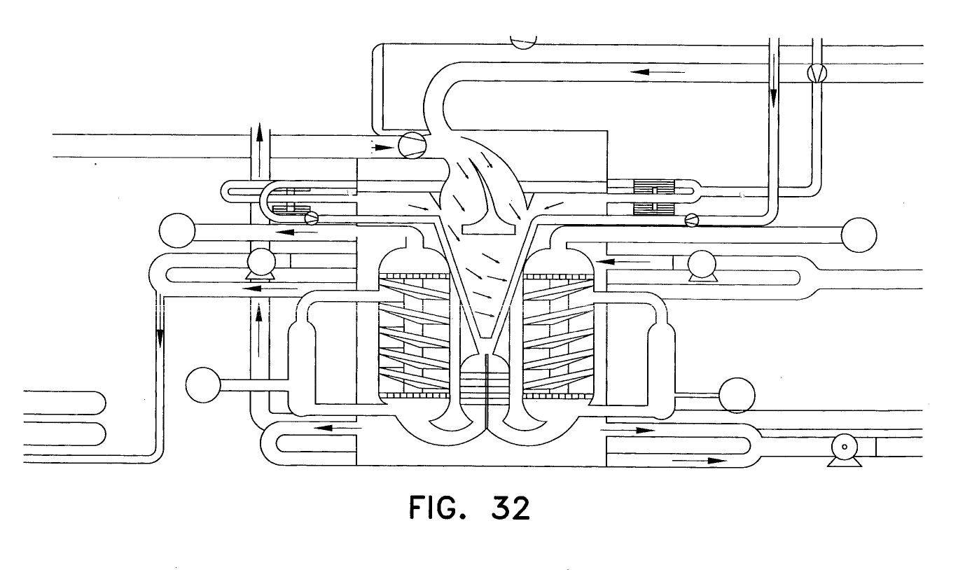

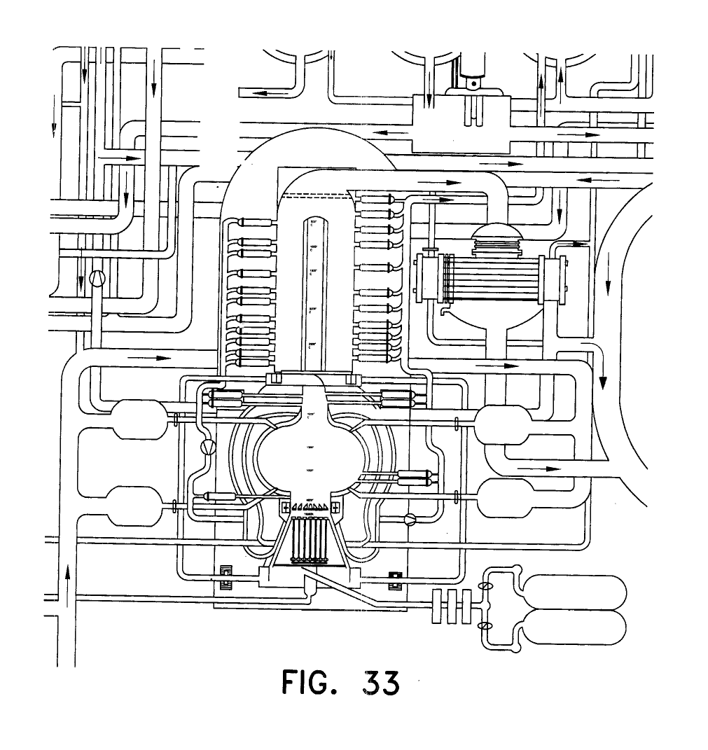

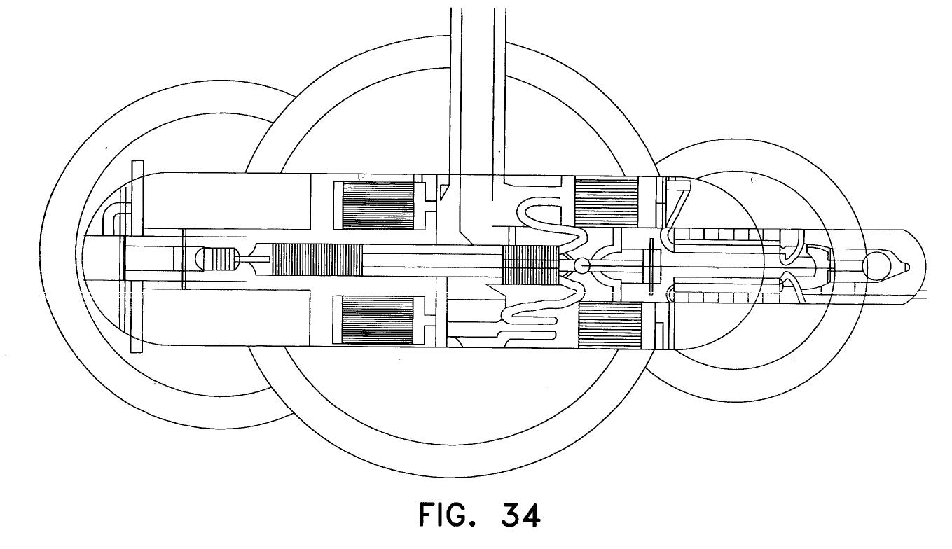

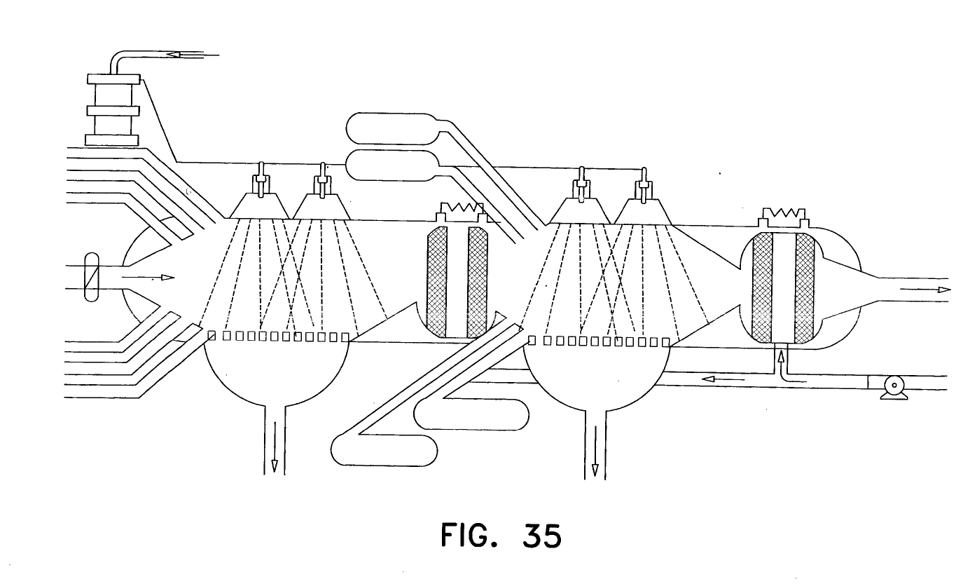

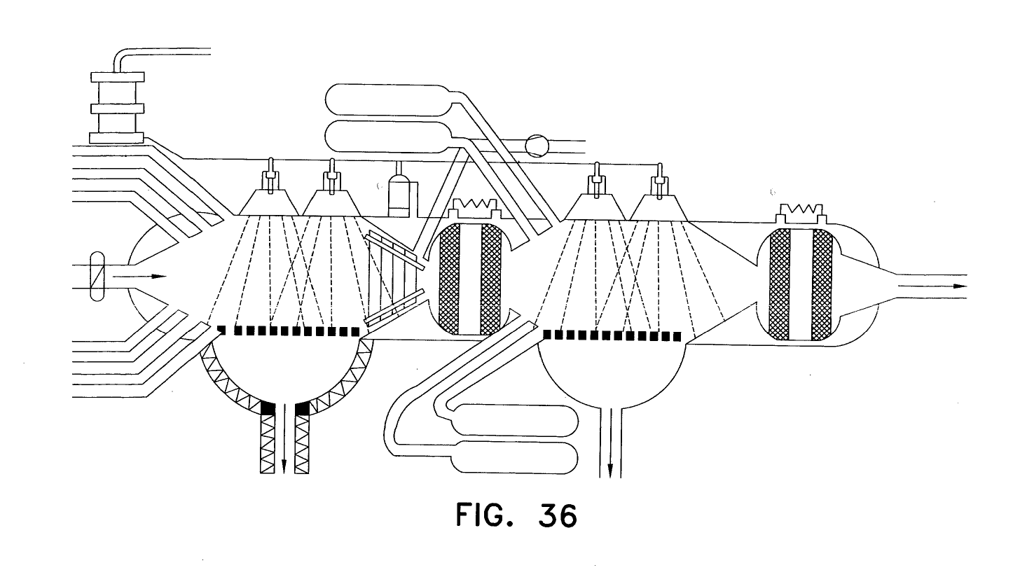

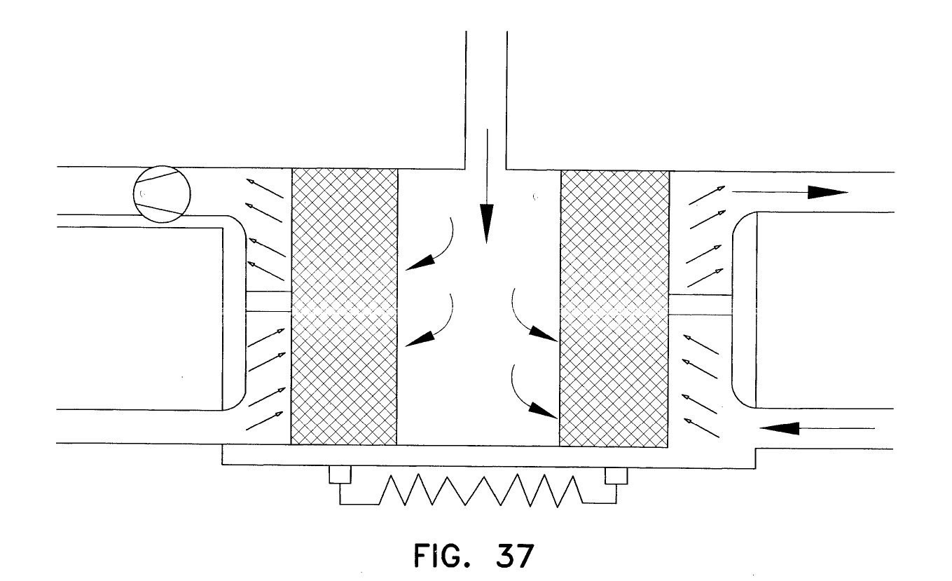

Invention Reactor System of FIG. 6
1. Pyrolyic Reduction System (pre-treatment reactor) (FIG. 11) comprising
A. Pretreatment Reactor,
B. Turbines with Power Generators,
C. Molecular Reduction Reactor,
D. Vortex Accelerator,
E. Vortex Precipitator
F. Pyrolic Reduction Reactor with wipe film/short path evaporator Vortex Cone
G. Vacuum Extraction Apparatus H. Extraction Scoop
I. Flex Extraction Duct System
J. Mobility Wheels or Treads
2. Slurry Treatment, Processing & Purification Reactor (FIG. 12)
3. Multi-functional Pre-Treatment, Processing & Purification Reactor (FIG. 13)
4. Pyrolyic Gasifier (FIG. 14)
5. Distillation Reactor with Nautilus Packing System (FIG. 15)
6. Side-Stream Advanced Hydrotreater (FIG. 16)
7. Hydrocracker with Secondary Purification Reactor (FIG. 17)
8. Advanced Hi/Low Temperature Fuel Processing Reactor (Advanced Fischer Tropsch Process) (FIG. 18)
9. Advanced Metals & Carbon Processing Reactor with Degassers (FIG. 199)
10. Gas Purifier Reactor with Fuel Cell Power & Filtration Integration (FIG. 20)
11. Atomizer Reactor (FIG. 21)
12. Nano Processing Reactor with Retractable and/or Gatling Gun Head & Growing Chambers (FIG. 22)
13. Zero Gravity Reactor (FIG. 23)
14. Waste Water Purification Reactor (FIG. 24)
15. Hydroelectric & Water Manufacture System (FIG. 25)
16. Molten Salt Distribution & Recycle Tank (FIG. 26)
17. Molten Metal Distribution & Recycle Tank (FIG. 27)
18. Helium Distribution & Recycle Tank (and/or Argon, carbon Dioxide, Hydrogen, Nitrogen, Air & Other Gas Alternatives) (FIG. 28)
19. High Temperature Steam Distribution & Recycle Tank (FIG. 29)
20. Plasma Distribution & Recycle Tank (FIG. 30)
21. Molten leaded Glass Distribution & Recycle Tank (FIG. 31)
22. Oxygen Distribution & Recycle Tank (FIG. 32)
23. Helium Nuclear Reactor—Zero Gravity Chambered—Rankine, Brayton and Carnot (FIG. 33)
24. Plasma Arc Reactor—Zero Gravity Chambered—Rankine, Brayton and Carnot (FIG. 34)
25. Molten Leaded Glass Nuclear Reactor—Zero Gravity Chambered Rankine, Brayton and Carnot (FIG. 35)
26. Advanced Steam Turbine—Zero Gravity Chambered Advanced Rankine Cycle System (FIG. 36); and
27. Molten Salt Fuel Cell (FIG. 37).

Combinations of reactors can create or transfer metals on an isotropic, isotopic, atomic or elemental form; mercury, lead, silver into gold, for example; new elements like metal hydrogen, metal kyrpton, metal xenon, rare earth magnets of great density and power, exceptional combinations and new elemental rare earth composites.

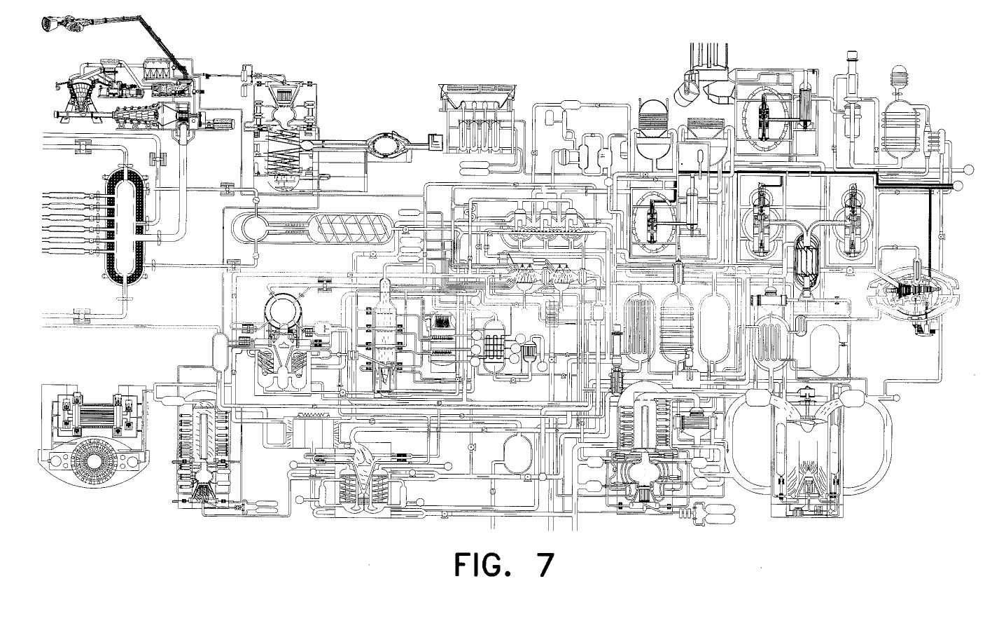

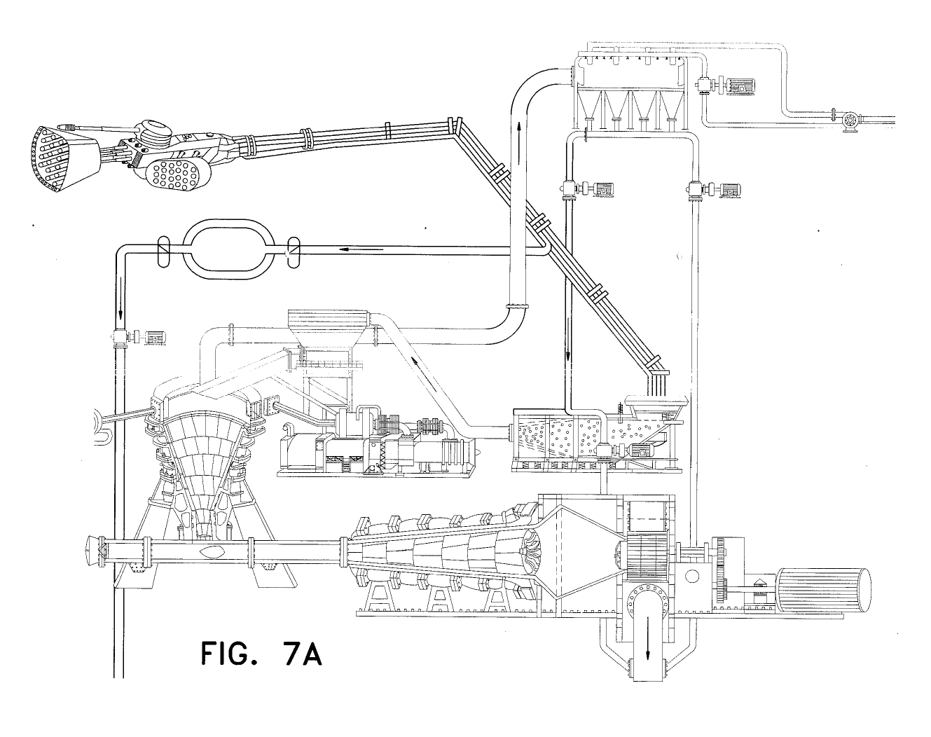

FIG. 7 shows the same embodiment as shown in FIG. 6 but in which the present core reactor K has been utilized as well as a mining system.

FIG. 7A shows the mining system. Figure X1 shows a vacuum mining apparatus shown in FIG. 7. Element (1) is a vacuum extraction cone with telescoping cutting boom, 360° radius turret, 90° tilt floor to ceiling; Surface high wall, tunnel, long wall, room and pillar and underground structure application. (2) is a long wall vacuum extraction scoop with mechanical shearer option—quarry, tunnel & long wall application. Element (3) is a continuous miner cutting head option—vacuum scoop system while the element (4) is a roadhead vacuum cutting head option—vacuum scoop system—(coal talc, salt, iron ore, bauxite, gypsum and others). (5) is an armored robotic crawler vehicle and (6) is an extending gas probe with vacuum gas extraction nozzle (50 foot extendable). (7) are fiber optic linked communication sensors and (8) is a gas probe turret and (9) is a lighting system. (10) is a sled mounted vacuum extraction piping system with ball and socket joint system while (11) is a mine gas vacuum extraction pipe. (12) is an ore vacuum extraction pipe—forward tunneling cone and (13) is an ore vacuum extraction pipe—long wall cutting cone(s). (14) is a probe sensor; (15) is an access hatch; (16) are hydraulic operated side panels; and (17) are pipe system bumper bars. (18) is a wet feed for continuous wet-head system and (19) is a hydraulic system to raise, lower and extend vacuum scoop apparatus with rotating cutter head. (20) is a side wall mechanical cutter vacuum scoop and (21) are cutting technology options in any combination or individually—hard rock and soft rock applications—Impact Laser—Plasma Arc—Plasma Arc (optional Hydrogen and Oxygen feed wet system)—Water Jet Cutter—hard Rock—Supersonic I Hypersonic Cavitation (Vortex Reactor generated sonic boom)—Mechanical cutters (#4,18, and 20); and (22) is hydraulic cone extension system.

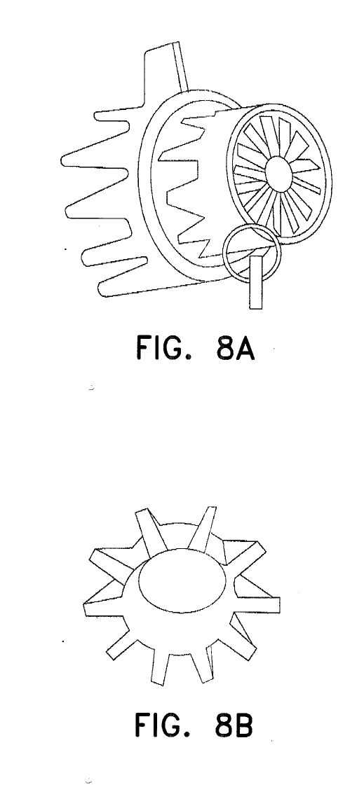

FIGS. 8A and 8B shows a multilevel flow diverter which demonstrates an alternative flow diversion from the primary ram air cowl into a primary swirl chamber and then into a secondary multiple flow chamber.

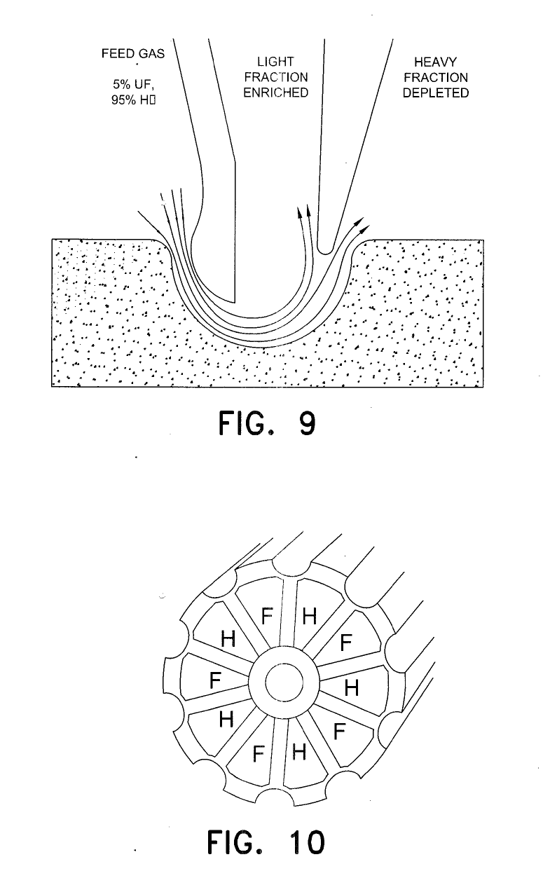

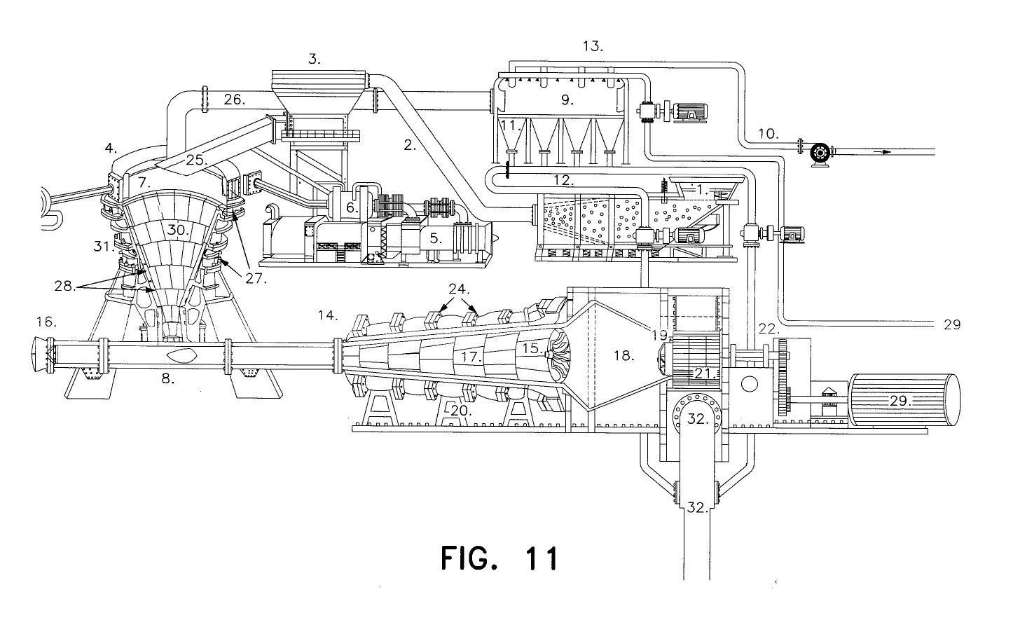

FIG. 9 shows a flow diverter which can be included in the present apparatus as a flow separating and classifying option.

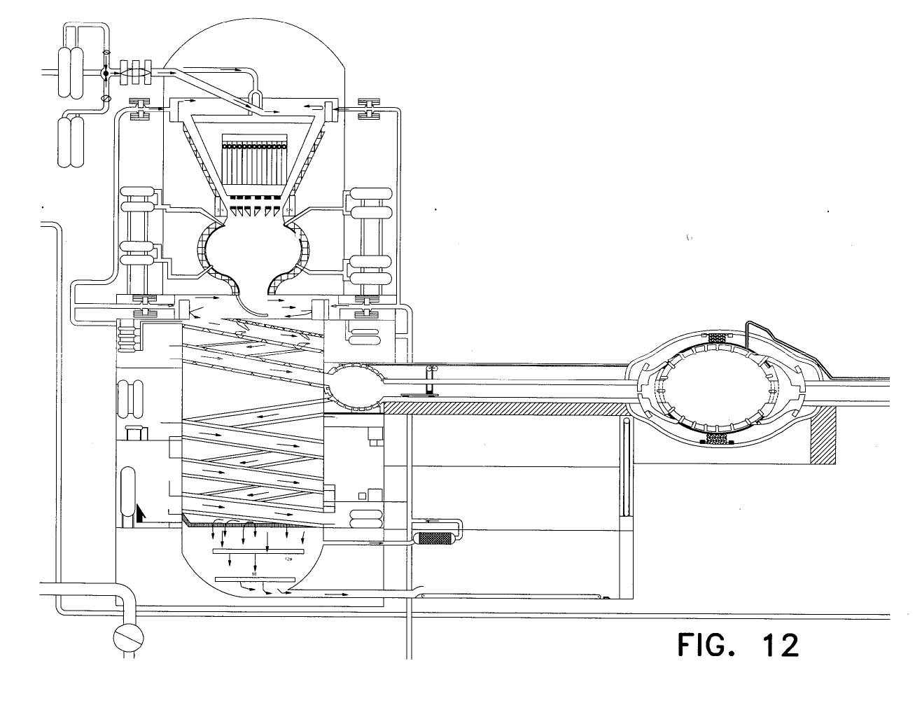

FIG. 10 shows a wheel appearing apparatus and represents the MAGLEV generator when situated in a swirl chamber. The spokes would be flux lines and the outer wheel the electric power generator.

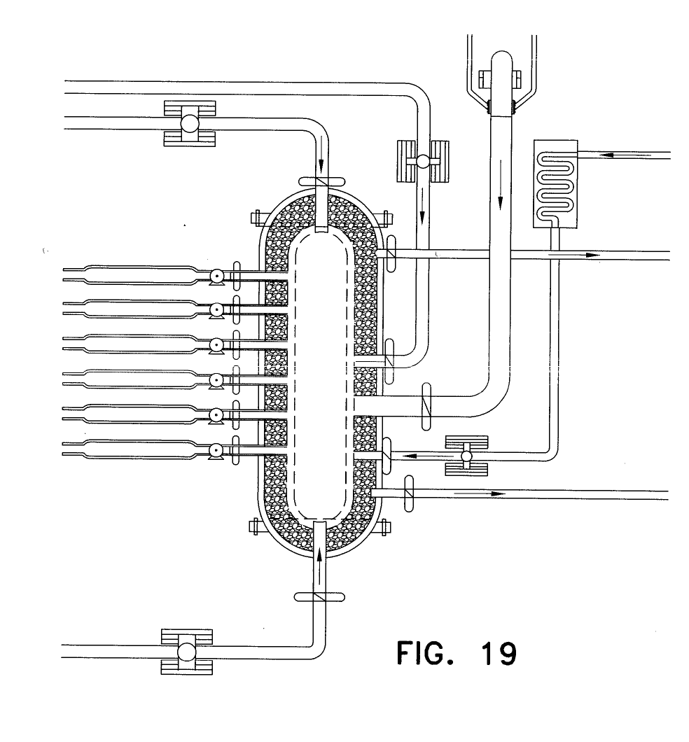

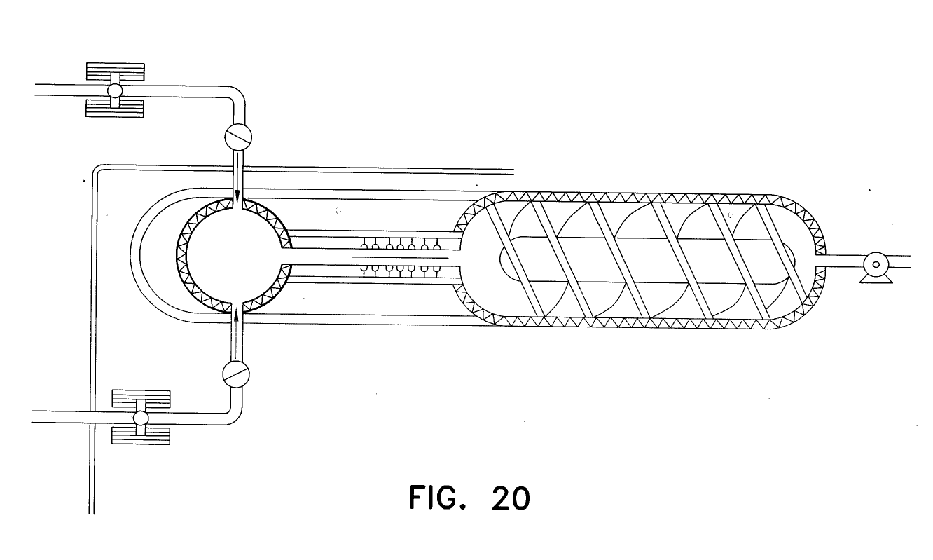

FIGS. 11-38 are portions of the Matrix including various reactors and processing plants.

### DETAILED DESCRIPTION OF THE INVENTION

The primary thermal and kinetic energy options useful in the present core reactor include, for example: combustion thermal-kinetic energy generation; chemical reaction energy generation; hydro-generated energy; nuclear thermal and kinetic energy; magnetic and electric generated energy. Combustion thermal-kinetic energy can include, e.g., a turbine exhaust stream, an ionized plasma exhaust stream, a rocket engine exhaust stream, pulse detonation, hybrid turbo-electric, or combined pulse detonation and hybrid turbo-electric. The chemical reaction energy generation can include both catalytic or chemical reaction energy generation. The hydro-generated energy can be hydrothermal vent steam hydroelectric and/or ocean wave energy. Nuclear thermal and kinetic energy generation can be by fission or fusion. Electric generated energy can electromechanical or electromagnetic generation where electromagnetic generation can be, for example, magnetoplasmadynamic thruster, magnetogasdynamics, pulsed-plasma or travelling wave. The electric generation may also be electrochemical or electrolytic generated. Primary power source(s) for the present core reactor which are electric generator linked include system self-generated power by various methods. Such methods include, for example, electromechanical generators, electro-dynamic generators, magneto (rare earth magnetic) quantum trapping, Penning Trapping, fuel cells, hydro-mechanical generation, or osmotic/salinity gradient (either reverse electrodialysis or pressure retarded osmosis). Other self-generated power can utilize: photovoltaic; piezoelectric/stepping motors; ultrasonic motors; Quantum Trapping including Bose-Einstein condensate and Josephson junction with the Miessner effect and flux pinning from a Type-2 superconductor options; ionized plasma flow; armature and rotor type system (Copper superconductor), including photons, krypton, xenon, etc.; and zero gravity vortex.

System and auxiliary electric power generation include: space propulsion and extraterrestrial power sources; industrial plant-wide power production; mobile combat power generation; and power grid including primary generation and reserve peak demand auxiliary.

Secondary thrust acceleration and thermal heat amplification options useful in the present invention include, for example, a combustion turbine engine with inlet afterburner with fuel and oxygen injection (and any alternate gas) with either kinetic flow amplification or thermal heat amplification or a variable flow nozzle. Kinetic flows of energy can include quantum particles, “God Particles” as confirmed by CERN of the Higgs Boson principle. Other options include chemical and/or catalytic injection nozzles having reactive kinetic flow amplification or exothermic heat amplification, pulsed detonation tube or electric generated auxiliary booster with ionized injection or anode/cathode nozzle.

The present core reactor can have various alternative flow upper reactor exit/entry ports. These include, for example, upper reactor energy beam exit port(s) with a propulsion thrust nozzle option or a directed beam exit port option, primary or ancillary power inlet source such as power generation or downstream ram air, coolant feed inlet, vacuum energy beam inlet feed for reduction processing feed inlet or extraction material transport, or collecting and harvesting of electrons or harvesting other materials for fuels as photons, dark matter into dark energy, krypton, xenon, etc. and hydrogen; a coolant system inlet feed and exit recycle ports.

Side-reactor mounted primary power inlet port(s) can include single upper parallel level inlet port(s) for up-flow thermal kinetic flow or optional downstream or mixed flow or combo, lower parallel level inlet port(s) for up-flow thermal kinetic flow or optional downstream or mixed flow, middle parallel level inlet port(s) for up-flow thermal kinetic flow or optional downstream or mixed flow, multiple parallel level inlet port(s) which allow for multiple flow streams such as for example processing streams, propulsion thrust stream exhaust stream, heat exchanger stream, or reactor coolant stream and injection and feed inlets and exhaust outlets.

The central reactor processing/propulsion/power stage can be comprised of various elements. This stage can comprise an inner helical path annular swirl chamber which comprises a conical multiplier ring inlet slot(s) option the slots having an upward flow option (ascending), a downward flow option (descending) or a mixed flow option (ascending/descending) in which the mixed flow option may be at a primary power parallel level (to an inner flow chamber and/or to an outer low chamber), a single open-flow inner swirl chamber which can be outer swirl/vortex accommodating with an inner chamber combustion option or an inner mix and/or separation option, a dual opposing flow swirl/vortex option, a vane impeller insert (vanes, fixed or stationary) for cyclonic flow which can be a rotor impelled fan which is ion charged, mechanical or electromechanical, swirl flow propelled or afterburner propelled or is a fixed impeller.

Inner swirl chamber combustion/processing options include: 1) a pyrolytic liquification system; 2) a gasification system; 3) pulse detonation systems; 4) a nuclear reactor system; or 5) a secondary propulsion system (optionally the same as the primary). The pulse detonation systems can encompass water manufacture (propulsion or water separation processes), pre-treatment chamber, thermal cracking, reforming or furnace Tundish, or house the electric power generator, a nuclear reactor and in a reverseable system house the rocket detonation, combustion pulse thrust apparatus(es) and exhaust nozzle.

Inner and outer surrounding dual swirl chamber options include, for example: 1) conical multiplier ring feed inlet slot(s) or optionally with added laminar air flow guides; 2) single open flow outer swirl chamber; tri-chamber processing and cooling system and multiple chamber processing, entrainment flow amplifying and cooling systems. The mixed flow option can be at a primary power parallel level to an inner and/or outer flow chamber. The tri-chamber processing and cooling system can be an inner processing, electric power generator chamber or nuclear reactor chamber, a secondary opposing flow swirl vortex wall with coolant buffer to the reactor wall and fuel of oxidizer feed for combustion, an outer swirl chamber or an outer coolant jacket. The multiple chamber processing and cooling system can comprise, for example an inner processing or reactor chamber, a secondary opposing flow swirl vortex wall, a secondary swirl chamber or vortex stream, or an outer coolant jacket or vortex stream.

There are various swirl chambers with central processing area options. Such options include, for example, a secondary combustion processing chamber, a rankine cycle steam boiler, a second stage propulsion combustion chamber, a nuclear reactor core chamber, a treatment chamber, and a central chamber mixed flow digital vortex/vortices can be sustainable or alternating temperatures with or without material, or fixed or non-rotatable impellers, driven impeller. The secondary combustion processing chamber can be, e.g. a pyrolic/hydropyrolic chamber, a gasifier chamber, a hydrothermal processing chamber, or an atomizer chamber. The secondary stage propulsion combustion chamber can be a hydroelectric looped power generation or a rocket engine. The treatment chamber can be utilized for, inter alia, sintering, carbonizing, cryogenic tempering, or catalytic conversions, for creating new elements, mercury, lead, silver into gold, for example, new elements like metal hydrogen, metal kyrpton, metal xenon, rare earth magnets of great density and power, exceptional combinations and new elemental rare earth composites.

The central chamber mixed flow digital driven impeller can have extreme flow amplification options either as an electromagnetically driven impeller or a swirl chamber flow driven impeller or can be for vacuum beam and energy beam generation.

Central swirl chamber upper-chamber feed port(s) include, for example, combustion feeds, catalyst feed port(s), reagents and/or solvent feed port(s), raw processing feed port(s), or nuclear fuel rod access port(s). Combustion feeds can include, for example, fuels, hypergolic propellant(s) or non-hypergolic, oxidizer(s), working fluid(s) (fission), photon beam, or cavitation ultrasound.

Center vortex updraft with conical multiplier rings can comprise stacked descending rings with multiplier air/gas feed, stacked inner linked parallel rings, spiral descending with multiplier air/gas feed, or parallel spiral ring with multiplier air/gas feed. Middle vortex versatile can be down, up or mixed draft. The outer vortex up or downdraft can comprise inner swirl chamber directional flow guides or an inner chamber processing vortex cone optionally with an outer vortex coolant chamber, jacket opposing vortex.

The reactor secondary processing/propulsion stage comprises a compressor, accelerator, processor, and separator. The inner cone feed options include a single or multiple feed option with a conical multiplier ringed inner cone which can be downward flow angled or can have a perforated cone wall. The perforated cone wall can have multiplier makeup gas feed ports, an outer cone opposing vortex flow, an electromagnetic cone insert, or a rare earth magnet, advanced rare earth magnet, element, composite of an advanced superconductor nature and properties, cone insert. The conical multiplier ringed inner cone can also comprise an inner vortex flow compression stage and hypersonic flow. The inner cone feed options also can include a flow inlet distributor ring option with simultaneous inner and outer cone vortex flow creation and a perforated cone to allow feed separation.

A central reactor ion thrust accelerator vortex cone can be an ionized gas feed version and/or comprise flow amplification utility options. Such options include for example propulsion thrust, advanced energy beam, processing and advanced impact milling including, e.g., vortex and reverse vortex impacts and impact explosion and implosion.

Cryogenic impact separation can occur by induced embrittlement or liquid embrittlement with various materials such as, for example: nitrogen; argon; oxygen; carbon dioxide; nitrous oxide; helium; hydrogen (orthohydrogen or parahydrogen) methane; propane; kerosene; or ethylene.

Cryogenic gas/propulsion fuel injection options include, for example: pyrotechnic ignition; high pressure combustion; 10 ton thrust at 10 km. per second, (UDMH) nitrogen tetroxide-unsymmetrical dimethylhydrazine, (MNH) nitrogen teroxide and monomethylhydrazine, or hydroxyl ammonium nitrate. Cryogenic gas/propulsion fuel injection options also include an electromagnetic vortex cone and an electrostatic vortex cone. The present core reactor may have secondary and third level mounted vortex processing cones. There may exist centripetal and centrifugal vortex forces and inner processing frusto-conical cone optional applications. Such optional applications may include, for example, primary flow compression, thrust acceleration, and cyclonic separation. Cyclonic separation may comprise, e.g., petroleum wiped film evaporator, implosive reduction and separation of solids and/or semi-solids, and hydrate flash melt and gas vaporization. Another possible optional application is as a nuclear hypersonic heat exchanger/radiator for, e.g. supercritical steam production.

Outer processing cone optional applications include a chambered/jacketed looped coolant system having a gas flow option using, for example, Helium, Argon, Xenon, Nitrogen, Propane, Carbon Dioxide, Oxygen, Hydrogen (fuel, processing), Krypton, Freon, and/or dry air. The chambered/jacketed looped coolant system can also comprise liquid jacket or coolant flow options utilizing water/steam, oil, liquid salts, light and heavy water, organic including, e.g. diphenyl or diphenyl oxide. The chambered/jacketed looped coolant system can also comprise molten liquid flow options, including, e.g. molten leaded glass and/or molten salts such as sodium or potassium salts, and fused salts, molten fluoride salt, and molten metal(s). Outer processing cone optional applications also include a perforated/non-perforated separation cone version utilizing a cyclonic centrifugal separator, a heated wiped film evaporator using liquids, gas, supercritical, semisolids, and nuclear.

The present core reactor comprises circumferential duct release outlet flow acceleration. There can be a central vortex positive ion energy beam option which accelerates the center vortex air, gas through a duct or which allows for the outer vortex flow to exit without slowdown. Thermal heat and thrust generation options include, for example: combustion; chemical; nuclear; geo-hydro mechanical; electrical; radiant; and sonic shock waves including, e.g. pulsed detonation and sonic amplifiers which can be ultrasound and/or scalar waves. Secondary thrust and thermal temperature amplification can comprise afterburner with variable nozzle and/or central inner vortex thermal flow. The central inner vortex thermal flow can comprise an ion vortex option via a center cone cathode or cone anodes. A nuclear vortex option can comprise, e.g., a nuclear thermal cone or a nuclear electro thermal cone. Opposing outer vortex coolant flow can comprise gas coolant either thermal or cryogenic, leaded glass coolant, molten salt coolant, and/or molten metal coolant. Internal reactor cooling system heat transfer options can comprise for example opposing outer vortex gas flow, or regenerative outer jacket including, for example molten leaded glass coolant, high temperature steam coolant, molten salt coolant, molten leaded salt, and/or molten metal coolant.

The present core reactor can comprise a cryogenic beam version. The cryogenic beam version can encompass, for example, cryogenic processing feed production, and/or cryogenic distillation. Cryogenic propulsion fuels include, for example, boron oxygen fluorine compounds, oxygen fluorine compounds, nitrogen fluorine formulations, fluorinated hydrocarbons, liquid fluorine difluride (OF₂), chlorine trifluoride (ClF₃), chlorine pentafluoride (ClF₅), hydrogen peroxide (H₂O₂), nitric acid and hydrazine fuel, nitrogen tetroxide (N₂O₄), and krypton. The cryogenic beam version can also comprise cryogenic hydrate gas liquid separation at sea level and/or subsea level. Additionally, this core version can comprise cryogenic cooling and effluent heat exchange, dewatering, entrained liquid and condensation removal with, for example, controlled condensate gas mix ratio, and a water degassing chamber.

The present core reactor can be used in various processes either stand-alone or system integrated or in a reversible or dual configuration such as the amplified inner vortex vacuum energy beam exiting one end of the reactor and at the opposite end the kinetic energy beam derived from the outer vortex flow. Amongst the processes in which the present core reactor invention can be used is propulsion. Amongst the high-hypersonic turbine apparatus versions of propulsion are: combustion propelled (carbon base fueled); detonation propelled; nuclear (thermal and/or detonation kinetic propulsion) including fission or fusion; electrically propelled including electromagnetically, electrostatic, electro thermal or magnetohydrodynamically propelled; cryogenically propelled; vortex energy beam propelled; sonic energy beam propelled; chemical reactive propulsion (catalytic); radiant energy propulsion (photovoltaic); plasma pulsed; and optionally—current art propulsion engines can be adaptable for core invention system integration.

The detonation chamber of the present core reactor and system may be also referred to as the “reaction zone”. Regarding the detonation technology of the present core reactor and system as reference to the apparatus explosive and implosive systems of propulsion, power and processing, the following are cited in relationship to the Brayton, Carnot and with slightly less frequently the Rankine Cycle: the Humphry Cycle (detonation process approximation by a constant volume process); the Fickett-Jacob cycle (one dimensional theory of Chapman-Jouguet theory of detonation); and the Zeldovich-von Neuman-Doring model of detonation (shock is considered a discontinuous jump and is followed by a finite exothermic reaction zone).

The present core reactor and system optionally includes: a quadruple linear implosive compression chamber with inert wave shapers; hyper-velocity shock tube for implosion or explosion application; colliding detonation wave compression; a sequential ring explosive system with or without a barrel; vapor shock wave compression refrigeration system which processes heat into cryogenic flows; and a valveless pulse detonation combustor.

Explosively pumped high-power electromagnetic pulse generation can be integrated into the invention's kinetic and thermal flows and/or its electric power energy storage system by its added; extreme current compression and amplification being able to create super electrothermal energy beams of over 100 MJ at 256 MA. Field strength can reach 2×10⁶ Gauss (200T); a pumped flux compression generator with high explosives and high power electromagnetic pulse by the super compressing magnetic flux and superconductor manufacture in order to generate extremely high-Hypersonic velocities and thrust; extreme compression for very high pressures and densities that produces millions of amps and tens of Terawatts exceeding the power of lightening; and extreme defensive or offensive energy beam applications.

Explosively pumped high-power electromagnetic pulse generation can also produce magnetic flux compression by a magneto-explosive generator; a hollow tube generator; a helical generator; or a disc electromagnetic generator (DEMG).

Related options which can be included in the present core reactor and system include: a quantum trapping, Penning Trap, combined and/or standalone hybrid MAGLEV turbine with advanced pulse detonation rpm supercharger acceleration; deflagration; pulse detonation; regenerative pulse detonation; an electromagnetic gun; or a ram accelerator.

The effects of detonation can be classified as hypervelocity accelerators, high dynamic pressure or gas dynamic expansion. All aspects fall within “shock and impact physics” covering flow density, velocity, pressure and enthalpy.

The detonation shock wave energy can be a primary power feed into the sonic energy beam chamber where it is further amplified to contribute in the creation of an intense sonic energy beam. The shock waves can alternatively be diverted into the thermal energy beam chamber as a method of amplifying a controlled, but extreme cavitation effect for thermal beam entrainment amplification.

The present core reactor and system energy beam invention's system of extreme velocity and centrifugal high pressure enables the creation of new and innovative vortex tube apparatus and processing applications. The categories of vortex tubes include: a counter-flow vortex tube; a uni-flow vortex tube; or a uni-flow vortex tube with cold air exit thru the concentrically located annular exit in the cold valve. This embodiment does not have a cold air orifice next to the inlet.

The invention Vortex Tube embodiments are distinguished by various modifications adapted to the desired utility and product. All invention versions have pre-compressed, filtered, humidified flows and enters the vortex tube through tangential inlets. An atmospheric air and space dark matter gas processing embodiment enables for the internal vehicle production of high yield, high purity liquefied oxygen, nitrogen, hydrogen, krypton and xenon amongst other gases, liquids and super critical feed. This vortex tube version separates and liquefies atmospheric gases thus serving as an internal self-generated fuel and operating system thermal and cryogenic energy source. The unique apparatus particulars can have tapered conical vortex cone geometry within a 2-phase counter-flow system having a minimum 3° to 7° diverging taper or more emulating outward from the tangential inlet port location. An internal adjustable cone valve seals the internal flow passage to vary the desired product yield. The external vortex tube shaft section is encased with a surrounding piped, ducted or jacketed chamber to regulate the vortex tube wall temperature with either a cryogenic gas flow or fluid. This allows any remaining processing gas(es) to condense and centrifuges it back out of the tube wall.

This apparatus can further have a contoured internal wall surface and the injection port side can be located on the converging end of the vortex tube for the exhaust. At the diverging end has been added an upstream MAGLEV axial compressor; regulated air cannon inlet nozzle(s); an inlet plane swirl generator; an automated pre-programmed and/or remote controlled adjustable internal cone valve; and two-opposing ball valve exit ports with integrated collection swirl chambers and flow exit ports to transport the cryogenically liquefied gases to either storage tanks or directly to the propulsion or processing pretreatment chambers. The exiting cryogenic stream is recycled back into the system

Cryogenic (current art) temperatures have been noted to max at 223°. However, with the present invention apparatus velocities, pressures and flow densities can achieve temperatures well below that average. The same applies to the thermal temperature (current art) average of 400° K outgoing flows to which the invention version also well exceeds.

The gaseous diffusion and effusion aerodynamic vortex tube embodiment can comprise an electron beam pre-filtering with foam metal substrated aerogel or Chalcogel filter; dual MAGLEV axial compressors to transmit parallel flow streams without mixing enhanced with a pulsed vortex gun detonated compression assist and a tangential high velocity, extreme compressed flow injection port.

The multi-level multiple cut system can comprise a tapered inner chamber vortex tube with stationary walled centrifuge, high-hypersonic pressure graduated diffusion primary separation chambers and vortex tube stacked secondary high-Hypersonic effusion separation chambers. The gaseous diffusion and effusion aerodynamic embodiment can also comprise upper level separated gas vacuum extraction port for transport to storage & or injection chamber and a vortex tube process gas extraction port for transport to a recuperator for recycle. Additionally, this embodiment further comprises ancillary electromagnetic and/or magnetic separation, liquid thermal diffusion, and rotating inner cylinder centrifugation.

Metallized gases and “new” elements or combinations such as mercury, lead, silver into gold, for example; metal hydrogen, metal oxygen, metal kyrpton, metal xenon, rare earth magnets of great density and power, exceptional combinations and new elemental rare earth composites, can enable a tri-atmospheric vehicle to illuminate the current art heavy and bulky fuel and oxidizer tanks which limit cargo space and comprise non-productive energy consumption. The present core reactor and system can utilize metallic gases and combustible metals in a wire form which can be spool-feed as a corresponding fuel and oxidizer for combustive propulsion, thermal processing and detonation applications.

The hydrocarbon fuels comprise: air; chlorine; fluorine; nitric oxide; nitrogen dioxide; and oxygen. Primary dark matter gases include: krypton; xenon; hydrogen; helium; and interstellar subatomic particles (Cosmic ray protons, neutrinos (3° K deep cryogenic temperature for internal vehicle processing), dust, and ionized metals.

Non-hydrocarbon fuels can include: acetylene; ammonia; arsine; butane; carbon monoxide; cyclopropane; ethane; ethylene; ethyl chloride; hydrogen; iso-butane; methane; methyl chloride; propane; propylene; dark matter gases yet to be realized; and silane.

Other fuels comprise explosives, vapors, gases, flammable liquids, solids, semi-solids and super critical materials and advanced metal composites.

Detonation compressed manufactured rare earth magnets and other products can create super conducting magnetic fields for use in the present core reactor and system, and can be manufactured with the core reactor and system. Likewise, these can be advanced composite rare earth magnets, even utilizing new elements such as mercury, lead, silver into gold, for example, metal hydrogen, metal oxygen, metal kyrpton, metal xenon, rare earth magnets of great density and power, exceptional combinations and new elemental rare earth composites.

The propulsion cowl of the present core reactor and system can comprise an adjustable flow guides which enable optimized ram air flows by atmospheric levels including take-off and landings, atmosphere re-entry and up to maximum ramjet levels. The flow guides include: a variable ram door; a secondary door; an engine bay vent door and a spill door. Cowls can also collect electrons and vacuum flows can act as a pulling effect like the physics of lift on airplane wings and propulsion of sails on a sailboat.

A space and orbital atmospheric embodiment can comprise an internal cowl, flow diverter transfer vane(s) linked to collection, separation, and dark matter processing apparatus. Primary cowl links flows for Casimir compression and related energy processing (“Dynamic Casimir Effect”).

With respect to power generation, the present core reactor is a high hypersonic generator apparatus. The present core reactor employs an advanced MAGLEV quantum trapped electric generator (or equivalents, to include Penning Traps or the like) as well as quantum levitated and propelled armature apparatus and is capable of producing high-Hypersonic RPM terawatt—petawatt output. The present core reactor can encompass kinetic power storage battery (secondary apparatus) as well as foam metal flywheels which can be cryogenically filled and MAGLEV propelled. The present invention power transport apparatus (delivery system) can comprise a cryogenic internal atmosphere and a high vacuum beam conduit grid. Current art electric generators can be made adaptable for integration with the present invention system.

Various processing and refining operations can be carried out utilizing the present core reactor and system. Amongst the procedures in which the invention system is useful is fractionation and separations. Distillation type apparatus with which the present core reactor and system can be used are atmospheric chamber, vacuum chamber, cryogenic optional atmosphere, azeotropic configuration or simple configuration.

A fractional invention jet nozzle cascaded packing system can include for example gaseous diffusion nozzle apparatus stacked etched foil separation nozzles, chip configured nozzle arrangement clamp cover plate secured, or assembly then flow tube packed light and heavy faction separation process. The system can comprise asymmetric cascading multiple-stream configuration central upward main flow tube encompassing downward tailing multiple flow stream tubes, light, intermediate and heavy fraction separation, extreme pressurized vacuum and atmospheric distillation chambers, laminar high-velocity gas flow, for example, raw carbon feed gas or injected processing gas(es).

The implosive vortex reduction reactor system can accommodate, inter alia, solid feeds, semisolids, liquids, gas, dark matter or supercritical materials. The extreme energy beam reactor of the present system can be employed either individually and/or as a combined version. The kinetic energy beam can be used for, for example, boring, drilling, solid impact fragmentation, propulsion, reduction or processing. The thermal energy beam (solid) of the invention can be used in, for example liquefaction, vaporization, gasification, dehydrating, Fracking, or processing. The Cryogenic beam of the present invention core reactor system can be utilized in, for example, Fracking, fragmenting, propulsion, cooling or processing. The present core reactor system (apparatus, processes and products) can comprise a vacuum energy beam or a sonic energy beam. The present invention core reactor system can be used in nuclear enrichment processing and atmospheric gas production into combustive and detonation fuels. Using the present core reactor, a hypersonic vortex uranium enrichment system could comprise a vortex fed, MAGLEV axial compressor which directly feeds into a single or cluster of tubular vortex tubes with internal multiple parallel interconnected effusion and diffusion chambers. The central flow tube may be fixed or rotating and the effusion level has a concentrated steam exit port for storage or combustion. Non-fuel or enrichment producting flows are routed back into the central flow for recycle from the diffusion processing level. Additionally, the system may serve as a vapor compressed refrigeration system working with or independently of the vortex tube cryogenic process, a modified vortex tube separator system, a cryogenic inert cooling system or laser diffuser (isotopically) selective irradiation. Conversions including decomposition and unification can be accomplished employing the present core reactor and system to provide processes such as, for example, pyrolysis, gasification, cracking (hydrogen, steam, or visbreaking), coking, reforming (catalytic) alkylation (catalytic), or isomerization (catalytic). The present core reactor and system can be used with treatment or blending processes. Such treatment or blending processes can be, for example, catalytic, hydrotreating, sintering, roasting, dehydration, sweetening, or mixing or blending. The present core reactor and system can be used with purification process including, inter alia, desulfurization, de-metallization, de-poisoning Ferro-, Para- and electro-magnetic capture and containment including rare earth magnetic. The present core reactor and system can be employed as an advanced filtration media for filtration and separations involving, for example, aerogels, Chalcogels, X-aerogels, sol-gels, substituted aerogels (including all of the above), advanced foam materials such as, for example, foam metals, foam composites, foam ceramics or foam carbon or graphite, advanced composite matrices, activated carbon, fuel cell filtered, molten salt filtration, E-beam bombardment and sonic energy beam. The advanced filtration media employable with the present core reactor and system include gaseous diffusion, aerodynamic process, integrated advanced vortex systems, or gas centrifuge. Products which can be produced using the present core reactor and system include electric power generation including, inter alia, DC current, AC/DC current, electric high voltage energy beam, or ionized electro-hydrodynamic power and thrust. An important use for the present core reactor and system is for water manufacture. Water such as, for example, fresh water, nano water, heavy water, produced water or super-critical water can be manufactured.

The present core reactor and system is useful in hydrogen and oxygen manufacture, and can be integrated into processes encompassed in the production of refined crude oil, fuels and re-refined oils such as crude oil, unconventional oil, carbon-based bio and pyrolic oils and waste oils. The present core reactor and system is useful in mining, extraction and mineral processing with respect to ores, minerals, metals, rare earth earths and precious metals. Fracking is another process in which the present core reactor and system can be employed. With the present core reactor Fracking can be carried out under extreme pressurizations, alternating thermal-cryogenic Fracking temperatures, extraction with looped recycle and processing of oil, gas and hydrates. The present core reactor and system can be employed with underground coal gasification, hydrate boring, extractions and processing as well as with gas boring, extraction and processing for, for example, natural gas, Syngas, LPG, propane, hydrogen, oxygen, methane (gas and hydrate), argon, helium, and coal mine gas including, raw gas (shaft mining and controlled burn, deep sea (hydrates, gas and oil) and deep well (hydrates, gas, and oil). Another area in which the present core reactor and system can be employed is mining and quarrying (minerals, ores, and metals). The transport and transport media of the present core reactor and system include MAGLEV, energy beam, vacuum beam, molten lead glass (thermal and kinetic) molten salt leaded glass, composite fiber optic (thermal and light), and levitation and zero gravity. The power resources generated using the present core reactor and system encompass an advanced matrix of apparatus and process technology spanning from the molecular to the mass industrial. Included, for example are exothermic and endothermic heat, cryogenic cold, sonic resonance, luminosity, thrust, vacuum and electromagnetism.

The present core reactors and processes include numerous terrestrial and extraterrestrial applications.

The present thermal beam and process can encompass extreme directed kinetic energy beam generation and distribution. The present invention comprises a propulsion engine which is as an aerospace chemical combustion engine which can comprise fixed-grid orbital track magnetic stators. The invention levitation turbine engine can comprise fixed-grid orbital track magnetic stators The stators may be permanent, segmented magnet track top layered with grade 55 and/or 38 Neodymium-Iron-Boron (NdFeB), 12 mm cube magnets in Hallbach array, and/or Samarium Cobalt. Further, the stators may be single or multi-magnet width track with tracks segmented by a laminated sheet with etched uniformly spaced inductor slots, magnets placed at 90° axis grain angles relative from each other. The vane and rotors may be cast or formed, or constructed to form, dual opposing unibodies which being tightly aligned and integrated and rotationally governed by the fixed track electromagnetic propulsion generate optimum kinetic energy, compression and torque in a vacuum, cryogenic and frictionless chamber. The rotor and vane rotational speeds may be supercharged by pulse detonation to achieve rotational speeds never before realized without bearing or shaft wear, tear and speed restrictiveness. The operating system can function as an advanced shaftless homopolar with dipole, quadrapole and total encompassing detonated implosive directed magnetic fields. As the vanes and rotors move along the track, the attached permanent magnets induce a current through each rail, which induces a magnetic field opposing the field of the permanent magnets. A Linear Synchronous Motor (LSM) propels the vanes & rotors. It consists of copper wire powered by 3ø AC Power wrapped around slots cut in laminated iron. The iron is laminated to eliminate eddy currents. A high powered electromagnet iron central track mounting plate can comprise permanent and electromagnet combined flux fields, and rotating magnetic flux field generation with magnetic polarization. A circular magnet composite grid (option) can comprise individual circular shaped permanent magnets arranged in a mass grid to form a generator apparatus with magnetically axial spun, zero to high hypersonic speed or uniformly throttled. A vortex beam capable of generating free quantum electron creation or interplay of coaxial electrons and vector-vortices at a rotational rate of the Larmor cyclotron, or of a zero frequency. The present core reactor or system is capable of extreme power and voltage generation.

Single or multi-tier track levitated vanes and rotors can comprise quantum flux trapped and levitated body internal bundled sapphire superconductor and composite coating options such as, for example (YBa₂Cu₃O₇-x), or Bismuth, strontium, calcium copper oxide. There can be a gold-plated outer. A sandwiched substrate filled with cryogenic liquid or gas including a foam ceramic composite (option), or an Aerogel, Chalcogel, Sol-gel (option). Ceramic encapsulated bundle (vane ad rotors) can be non-conductive or of cryogenically activated superconducting construction. Zero to high-Hypersonic orbital rotation is achieved by speed actuation and control employing electromagnet transformer either speed throttle with load compensation control or a brake/reverse flow actuator. Multilevel flow paths (option) include opposing flow directional (AC power) or Staged unidirectional flow paths (DC power). Compression and expansion vortex chambers comprise a high compression stage and low pressure. There can also be included a vortex tube generated Cryogenic atmosphere. This embodiment can also comprise propulsion, guidance, levitation and support. Staged thrust options include, for example, zero to high-Hypersonic speed, current art compatible engines including: turbine combustion engines, rocket engines, hybrid integrated power engines such as ramjets, scramjets and turbojets, or combined cycle.

Electric power generation and storage within the scope of the present core reactor and system can be described as an advanced power system. The present core reactor and system comprises an inventive megawatt to petawatt electric power system which includes a quantum levitation generator-electric motor. The quantum trapped MAGLEV levitation generator has a fixed magnetic stator track with an outer magnetic conducting surface using a permanent magnet option, a hybrid superconductor system option or an electro-magnetic option and an on-demand electric power storage mode which includes rotational speed acceleration by pulsed detonation or hypersonic flow air cannon which are enhanced by the quantum trapped cryogenic vacuum atmosphere with in the chamber enclosure. The generator can have a central mounting plate (e.g. an iron core), a bottom configuration with a dual opposing AC/DC current or a DC current option. The generator further can comprise levitated hypersonic traveling rotor. The rotor construction can be, for example, a non-conductive advanced ceramic encapsulating shell with outboard side pure copper plate surface or an inboard side advanced ceramic shell. The generator can further comprise, for example, a central Sapphire superconductor (option) comprised of, for example, yttrium, barium, copper oxide coated both sides or a gold sputter deposition sealed outer surface. A niobium-titanium or niobium-tin embodiment is a further option. The generator can further comprise a non-conducting inner packing comprised of, for example a Chalcogenide aerogel, or sol-gel oxide sandwich layering the conductor or porosity to contain the cryogenic fluid or gas to sustain a minimum about a 90° K temperature. A hypersonic rotor accelerator including, e.g. an air cannon can comprise an embodiment of this element of the core reactor which can operate in a cryogenic atmosphere (about 90° K or below).

The invention power storage apparatus can comprise, for example, a demand accelerator controlled generator or a spiral vortex power storage system. The thermoelectric converter can comprise, for example, a thermal-to-electrical converter designed for using multi-phase alternating currents to produce both radial and longitudinal moving magnetic fields, resulting in opposing twisting forces, and also for using multi-stage collectors with multidirectional energy flow, in order to facilitate generating electricity from thermal energy in a more efficient way. Primary power options include, inter alia, a current air turbine or a current art combustion engine. Secondary power generation can comprise, for example a levitation turbine apparatus. The present system can be directed energy beam powered or can comprise a secondary propulsion amplifier. Applications of the present reactor and system embodiment include, for example, an advanced power grid system, an aerospace self-generating system, marine power systems, or vehicle power systems. Invention electric power storage apparatus includes, inter alia, quantum levitated coils, or an ionized plasma vortex armature. The first stage thrust and exhaust powered apparatus can comprise heat amplification and thrust acceleration apparatus options including optional exhaust nozzle options with or without afterburner(s) (aerospike, plug, bell, cone, or expansion/deflection). Further elements can comprise a swirl chamber afterburner fuel and/or oxidizer injection element or an ancillary ram air or gas injection element which can comprise, for example a central high temperature steam boiler with an injection system. The second stage transonic to hypersonic speed element power generation options include, inter alia, magnetohydrodyamic power, an ion thruster, detonation or a plasma arc. A swirl chambered vortex generator can have a fuel injection intensification option and/or a central impeller flow intensifier option or an electric option. This embodiment can be multi-fuel capable with or without an oxidizer and can comprise an ionized vortex cone and power stream or a perforated cone wiped film evaporator. Third stage hypersonic to high-hypersonic speed thrust options and re-entry stage power generation is optional. Third stage thrust options include, for example, magnetohydrodyamic or pulse detonation.

Further embodiments of the present invention include a land and sea chemical combustion engine and aerospace thermonuclear propulsion. In the aerospace embodiment, current art thermonuclear reactors including molten salt (preferred) and high temperature gas cooled including the inventive molten leaded glass cooling system can be employed.

Another embodiment in which the present core reactor and system can be employed is in aerospace cryogenic propulsion. Fuel options in this embodiment include, for example, LOX and liquid hydrogen and bi-propellants LH-LOX. The present core reactor and system can be employed in processing force energy in a molecular to mass scale. Extreme deep cryogenic temperature generation can be used via vortex tube (invention), propulsion, processing treating and reduction utilities. A directed energy hypersonic impact beam can be used in utilities such as, for example, boring, Fracking, mining and extraction, solid mass, semi-solid, liquid or gas impact beam, vaporization and/or combustion or fracturing either reduction and/or destruction, compact linear collider reactor, projectile launcher and propelling apparatus. Further embodiments include extreme thermal kinetic energy beam and extreme cryogenic kinetic energy beam including a cryogenic looped Fracking system which is mobile or non-mobile. The cryogenic embodiment can comprise a cryogenic pulsed-energy beam boring head with surrounding outer extraction pipe and a rotating augur extraction or extreme vacuum removal. Dry ice pellets with a rail gun force energy beam bore action can be used for evaporation on impact. A looped system using no chemicals, water or causing pollution can comprise an access feed perforated bore hole, horizontal target extraction area, optional parallel drilled extraction exit bore, a main bore could serve as both feed and extraction exit and gas and oil separation for recycle and well head pretreatment processing. A four-stage fracturing and recycle process embodiment can comprise a first stage supercritical cryogenic gas hypersonic pressurized fracturing media which can be alternated with second stage to speed up extraction process and pressures can be adjusted and/or pulsed to allow liquid drainage. Second stage combined hypersonic thermal and sonic energy beam fracturing can employ horizontal pressurization and “thermal shock” fracturing extreme sonic beam fracturing assist. Third stage extreme vacuum extraction can encompass all process and any pocket gas (es) as well as all liquids for processing. A fourth stage can encompass hydro cyclone pyrolic gasification including gas and oil slurry separation vortex impact mill, solids reduction, wiped film evaporator filtration, dehydration and wellhead oil pre-treatment. An extreme vacuum beam generation system can be employed in the extraction (solid/semi-solid, liquid, gas and supercritical), transport, collection and processing, implosion mill, detonation, processing and propulsion shock suppression, electric power and/or thermal heat distribution and transport. Extreme exothermic ad/or endothermic temperature generation options include, for example, plasma, Nuclear (fission and/or fusion), chemical, catalytic, supercritical, and radiant photovoltaic (utility scale). Extreme high power thermal optical laser beam generation in extreme vacuum can be by an advanced optical system or advanced vacuum fiber optical transport media.

Extreme luminescent amplification resource options include, inter alia, thermo luminescence, incandescence, electro-chemiluminescence, electro-luminescence, crystallo-luminescence, mechano-luminescence, photo-luminescence and ionization, radio-luminescence or sonoluminescence. Extreme thermal sonic energy beam generation reactor can employ compression wave, detonation/combustion shock wave, ultrasonic waves, electronic beams, radio waves, or microwaves and cavitation.

A central plant thermal heat supply and distribution version can be employed in electric power generation including, for example, electric pulse generation, an ionized plasma generator, and a quantum trapping generator invention or a detonation power generator.

Pre-treatment/post treatment reactors are further embodiments in which the present core reactor system can be employed. Such reactors can be used for separation either thermally, cryogenically, catalytically or centrifugally. These reactors can be employed for purification by filtering, sieving or ultrasonically. Treatments can be chemical or thermal, for example and the reactors can be used in mixing operations. Upstream raw feed reactor variations include, for example liquid slurry feed, gas feed, hydrate feed, solid and semi-solid feeds, and supercritical feeds

Downstream post treatment recycle feed variations include fuel processing, nuclear fuel reprocessing reactor(s), spent fuel purification and enrichment, or radiated waste leaded glass encapsulation.

The present core reactor and system can be employed with gasifier reactors, including, for example, a pyrolyic converter, a syngas (Fischer-Tropsch) converter, a raw wellhead gas gasifier, a hydrate converter gasifier or an underground gasifier system.

An additional embodiment in which the present core reactor system can be employed is with Molten Feed Treatment and an E-Beam Purification Reactor. Such embodiments can be used with liquid and/or molten liquid feeds, gas feeds, semi-solid feeds (metal and metal ores purified and degassed), or supercritical feeds.

A still further embodiment in which the present core reactor and system can for employed is with distillation reactors. The distillation reactors can be thermal vacuum and/or atmospheric distillation or cryogenic vacuum and/or atmospheric distillation.

A still further embodiment in which the present core reactor and system can for employed is with molten leaded glass reactors (nuclear and/or plasma reactors) including, for example, Molten or liquid nuclear fuel system including an operating radioactive safety shield, an emergency reactor melt-down system encapsulator, a Brayton Cycle application, a Rankin Cycle application or a Carnot Cycle application.

Still yet further embodiments with which the present core reactor and system can be use are: plasma reactors including atomizer and extreme high-temperature. processing reactors for mineral, metal, rare earth & precious metals ore or foundry melting and smelting furnaces, propulsion engines, ionized plasma propulsion and/or electric power generators, or extreme thermal ionized kinetic energy directed laser beams. Also possible embodiments include; zero gravity reactors with a manufacturing chamber, a processing chamber, a turbine operating chamber (bearing and rotatable longevity) or a treatment chamber; hydro-electric power generation and water manufacture including hydrogen and oxygen plasma pulsed detonation reactors, detonation shock wave generated hydroelectric power, and utility scale mass water manufacture; and plasma generated high temperature steam production; water purification and recycle reactors including sour water, waste water, heavy water, and nano water; nano processing reactors; molten fuel cell reactor system including electric power generation and electric storage system, or molten salt electrolyte including filtration processing stream flow through and molten salt looped matrix system. Such systems can be molten leaded glass or molten glass insulated or an electro catalytic membrane fuel cell version.

Yet further embodiments which can employ the present core reactor and system are: an atomizer reactor with waste stream purification, separation and/or conversion; incineration; molecular vaporization separation, capture and recycle, powdered metal production, carbonization, or a refinery flare absorption chamber; or invention internal reactor components including, e.g. a Nautilus reactor packing system, Chalcogel substrated filtration (foam metal invention); aerogel insulted reactor walls, foam rare earth magnet purification filter, or water gas shift electrolyzer fuel cell reactor using hydrogen or oxygen.

Water of the highest purity can be produced using ion-exchange processes or combinations of membrane and ion-exchange methods described herein. Cations are replaced with hydrogen ions using cation-exchange resins; anions are replaced with hydroxyls using anion-exchange resins. The hydrogen ions and hydroxyls recombine producing water molecules. Thus, no ions remain in the produced water. The purification process is usually performed in several steps with “mixed bed ion-exchange columns” at the end of the technological chain. An embodiment of this EFSMP creates Carbon Fiber, and or nanotubes, from Carbon generated as a product of the SMP's herein, and include such examples of Carbon fiber is mainly made from a polymer called polyacrylonitrile (PAN) by drawing/spinning a filament, passing through a specific oxidation heat treating, carbonizing heat treating and surface treatment process, with the spinning techniques, non-mechanical water treatment, and the like, used in industry, but not limited to, are those such as wet spinning, sedimentation, centrifugation, evaporation technologies, dry spinning, air gap spinning and melt spinning The various heating process steps include oxidation, pre-carburizing and carbonizing. The main surface treatment processes include electrolyte, washing and sizing, and the like. The other sources of the carbon fiber to produce from are petroleum or coal based pitch (pitch precursor) and rayon (cellulosic precursor), all of which are products created, or are byproducts of processing, within the EFSMP, and have been described herein. In addition to the previous description described herein, the EFSMP employs design and technology in advanced heating element design and insulation packages, which have greatly reduced energy consumption—like those of making Harpers International, carbon fiber LT, HT, and UHT furnace systems, as well as utilizing, but not limited to atmosphere purge chambers, where such chambers, individually, or in tandem, parallel, hybrid, and the like, improve product quality and extend the useful life of the insulation, and whereas such can also effectively stripping incoming material of entrained particulate.

A pre-pyrolysis reactor comprises a continuous system and method in which a slurry (fuel applies to the same system utilized in the power generation plant) composition including: crushed coal, micronized tires (coal to tire/battery mix weight ratio, 1:1; micronized battery cases, 1:2; carbon black optionally, 1:3; under atmospheric pressure in a hydrogen, propane or mix environment, 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100-270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel or X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system. The purified slurry vapors are then vacuum pump extracted and can be forwarded into a pyrolysis chamber.

Pre-Pyrolysis Reactor

A pre-pyrolysis reactor comprises a continuous system and method in which a slurry (fuel applies to the same system utilized in the power generation plant) composition including: crushed coal, micronized tires (coal to tire/battery mix weight ratio, 1:1; micronized battery cases, 1:2; carbon black optionally, 1:3; under atmospheric pressure in a hydrogen, propane or mix environment, 1:4) and a residuum blanket oil for prevention of spontaneous combustion and for deasphalting and further pyrolysis processing into oil and/or syngas. The syngas is then sent to the syngas line, for use as internal fuel source, and/or processing into a finished fuel gas. The pre-treated slurry is passed through several reactor heat Cells as it passes from the feed entry port with a temperature of 100-270 degrees Celsius for moisture extraction and then to a vaporizing temperature of 270 to 350 degrees Celsius. Heat is provided by infrared, microwave or convection means. The slurry/vapors are filtered by vacuum extraction and capture of carbon soot and ash forming compounds such as quartz, mullite, pyrite, carbonate, phosphates, actinides, sulfur, moisture and metals in a Chalcogel or X-Aerogel filtration system. The slurry and vapors are continuously mixed and pushed toward the reactor exit port by an Archimedes screw running lengthwise through the center of the reactor with the assist of ultrasonic cavitation aiding desulfurization at 20,000 cps. Coal fines can be utilized in the pyrolysis process with this pre-treatment system. The purified slurry vapors are then vacuum pump extracted and can be forwarded into a pyrolysis chamber.

Zero Gravity Reactor

A zero gravity (ZG) reactor can be used with a specific purpose, or can have multi uses or versatilities. The ZG reactor can be used for manufacturing foam metals, for example. The ZG reactor can be for housing generators in a float zone to create electricity or can be used for fabricating components or for manufacturing foam glass. An embodiment of the present invention comprises a weightless environment reactor having atmospheric manipulation or the reactor can have no atmosphere. The present reactor can produce pressures similar to that of an autoclave, and can create a vacuum environment with negative pressure.

Metal Foams

Metal foams can be created under varied gravitational conditions ranging from microgravity to zero gravity, but zero gravity is preferred. In a zero gravity atmosphere, the gases being injected into the metal would diffuse evenly and completely without being squeezed out or collapsed by the weight of the base metal being processed. A zero gravity apparatus additionally has a viscosity-increasing effect making solid particles the dominant mechanism because of the illumination of the driving force for drainage from the solution. Metal foams produced in a zero gravity apparatus provide a method for creating a super alloy substrate with a controlled uniform, mixed or layered pore size, shape and dimension within a Chalcogel, Aerogel, Xerogel, Sol-gel or Nano colloid filter, being lighter and stronger than any prior art. When utilized with Nano it is possible to create a self-repairing membrane for use in microbial fuel cells, a method of bone graphing and pharmaceutical applications, and numerous other applications.

1. A core reactor comprising a multistage single, dual, multi-directional or reversible flow system including at least: 1) a power generation stage; 2) a power amplification stage or stages; 3) an apparatus feed and/or an internal processing system; and 4) an optional flow recycle and/or propulsion stage.

2. (canceled)

3. (canceled)

4. (canceled)

5. (canceled)

6. The core reactor according to claim 1 wherein the reactor optionally includes the following interconnected components: 1) a primary kinetic energy device(s); 2) exhaust nozzles; 3) single or multilevel swirl chambers; 4) single or multiple conical vortex cones; and 5) modified vortex tubes(s) for cryogenic, sonic or extreme thermal heart generation streams.

7. The core reactor according to claim 6 wherein the first stage power generation comprises one of primary kinetic power generation and primary thermal heat generation.

8. The core reactor according to claim 1 wherein the core reactor is configured for generating/storing electricity, or electrical power and/or energy beams including: 1) exothermic and endothermic heat; 2) cryogenic cold; 3) sonic resonance; 4) luminosity; 5) thrust; 6) vacuum; and 7) electromagnetism.

9. The core reactor of claim 1 wherein the power amplification can be: 1) exhaust nozzle flow amplification; 2) centrifuge power amplification and first stage gas separation; 3) quantum MAGLEV levitated inner swirl chamber flow amplification; and 4) induced flow merging convergent low conical vortex cone(s) including inner flow cone flow compression and outer vortex cone flow entrainment and amplification.

10. The core reactor of claim 6, wherein an apparatus feed and/or internal processing system optionally includes: 1) a vortex tube system self-generating (internal systems) including an extreme thermal heat processing stream, an extreme magnetic, an electromagnetic or superconductive flux field, or an extreme cryogenic cold processing system; and 2) a central chambered pulse detonation tube(s) including: a) a feed processing distribution cap to detonation tub; b) detonation compression; c) an advanced separation nozzle system; and d) a separated feed collection and removal system.

11. The core reactor of claim 10 wherein the core reactor is adapted for propulsion phase, quadrapole detonation, compression and/or a combined Penning Trap.

12. The core reactor of claim 7, wherein an apparatus feed and/or internal processing system optionally includes: 1) a vortex tube system self-generating (internal systems) including an extreme thermal heat processing stream, an extreme magnetic, an electromagnetic or superconductive flux field, or an extreme cryogenic cold processing system; and 2) a central chambered pulse detonation tube(s) including: a) a feed processing distribution cap to detonation tub; b) detonation compression; c) an advanced separation nozzle system; and d) a separated feed collection and removal system.

13. The core reactor of claim 8, wherein an apparatus feed and/or internal processing system optionally includes: 1) a vortex tube system self-generating (internal systems) including an extreme thermal heat processing stream, an extreme magnetic, an electromagnetic or superconductive flux field, or an extreme cryogenic cold processing system; and 2) a central chambered pulse detonation tube(s) including: a) a feed processing distribution cap to detonation tub; b) detonation compression; c) an advanced separation nozzle system; and d) a separated feed collection and removal system.

14. The core reactor of claim 9, wherein an apparatus feed and/or internal processing system optionally includes: 1) a vortex tube system self-generating (internal systems) including an extreme thermal heat processing stream, an extreme magnetic, an electromagnetic or superconductive flux field, or an extreme cryogenic cold processing system; and 2) a central chambered pulse detonation tube(s) including: a) a feed processing distribution cap to detonation tub; b) detonation compression; c) an advanced separation nozzle system; and d) a separated feed collection and removal system.
